(19) United States
(12) Patent Application Publication
(10) Pub. No.: US 2021/0016786 A1
(43) Pub. Date: Jan. 21, 2021

(54) Predictive Vehicle Diagnostics Method

(71) Applicant: We Predict Limited

(72) Inventors: Anthony Peter GRIFFITHS, Newton (GB); Christopher Lee DAVIES, Sketty (GB); James Gareth DAVIES, Ann Arbor, MI (US); Stephen David NORRIS, London (GB); Patrick James TUDOR, Sketty (GB); Timothy Peter DAVIS, Warwick (GB); Kelly Marie NOCK, Cardiff (GB); Steffan Rees, London (GB)

(21) Appl. No.: 17/032,294

(22) Filed: Sep. 25, 2020

Related U.S. Application Data
(63) Continuation of application No. PCT/EP2019/057638, filed on Mar. 26, 2019.

(30) Foreign Application Priority Data
Mar. 27, 2018 (GB) 1804886.8
Mar. 27, 2018 (GB) 1804888.4
May 31, 2018 (GB) 1808881.5

(51) Int. Cl. B60W 50/02; B60W 50/14

(52) U.S. Cl. CPC B60W 50/0205; B60W 50/0225; B60W 2050/146; B60W 2050/143; B60W 50/14

(57) ABSTRACT

A computer-implemented method of predicting vehicle failures comprises: receiving, at a processing stage: i) a vehicle diagnostics dataset, which records historic diagnostic warning events and an associated timing for each diagnostic warning event, and ii) a vehicle fault dataset, which records historic vehicle fault events and an associated timing for each vehicle fault event, wherein the diagnostic warning events and vehicle fault events are associated in their respective datasets with cooperating vehicle identifiers; wherein a predictive algorithm executed at the data processing stage determines whether or not each diagnostic warning event of a target type is time-associated with a diagnostic warning event in that its associated timing is within a predetermined time window relative to that of any vehicle fault event associated with a matching vehicle identifier, and computes, based thereon, a significance value for the target type of diagnostic warning event, the significance value denoting the likelihood of a vehicle fault event occurring should a diagnostic warning event of the target type occur.

### CROSS-REFERENCE TO RELATED APPLICATIONS

The present application is a bypass continuation application of International Application No. PCT/EP2019/057638, filed on Mar. 26, 2019, which in turn claims claims priority to GB Application No. 1804886.8, filed Mar. 27, 2018, GB Application No. 1804888.4, Filed Mar. 27, 2018, and GB Application No. 1808881.5, filed May 31, 2018. Each of these applications is incorporated herein by reference in its entirety for all purposes.

### TECHNICAL FIELD

This disclosure relates to vehicle diagnostics.

### BACKGROUND

Most modern vehicles are equipped with some form of on-board diagnostics data collection system that records data about the state of the vehicle for use in performing diagnostics (diagnostics data). This is generally in the form of sensor readings, though at least some of it can come from other sources, such as self-reporting from on-board computers. As automotive technology develops, more and more aspects of a vehicle's state are monitored and recorded using increasingly sophisticated sensor systems and other monitoring components, to the extent that, in some of the newer vehicles available today, in its raw form, the volume of raw diagnostics data that is generated can exceed 1 Tb per day for a single vehicle.

For some time, vehicles have been equipped with on-board information extraction functionality, whereby a vehicle can extract, from the raw diagnostics data, what is considered, from an engineering perspective, to be the most relevant information, and store it in a convenient form. This “summarizing” of the raw data is a form of self-diagnosis and reporting, which is referred to in the automotive industry as on-board diagnostics (OBD). An on-board diagnostics data collection system having such OBD functionality may be referred to as an OBD system herein.

An OBD system may provide an event-driven summary of the raw diagnostics data it collects, by recording the occurrence of certain types of event. These are specific types of event that are predetermined based on human engineering knowledge and expertise. This can be based on a system of “diagnostic trouble codes”, where each evet type is associated with a unique DTC. This provides a (to some extent) standardized mechanism for detecting and reporting such events. The output of a DTC analysis over time is a record of which DTCs have been triggered at which times, which is a form of summarized (as opposed to raw) diagnostics data as those terms are used herein. In this context, the event that triggers a DTC code may be referred to as a DTC event.

Even the less sophisticated OBD systems in use today use extensive DTC sets. For example, the OBD2 specification provides a widely-adopted set of “basic” DTCs (also referred to as OBD2 parameter identifiers, or OBD2-PIDs), which are nonetheless extensive. Many manufactures also add their own DTCs on top of this, and as such the DTC sets used in certain vehicles today can be vast. DTC sets can cover factors as diverse as vehicle mechanics (pedal position, throttle position, wheel alignment etc.), fuel/fuel-tank state (composition, temperature, pressure, level, fuel-air ratio, solenoid state), ambient air, on-board computer errors (failed read/write operations, communication errors etc.), vehicle speed/acceleration/breaking, exhaust pressure, ignition, service interval (i.e. time since last service), battery state, engine state (engine temperature, RPM, engine torque), coolant temperature etc. Accordingly, even though a vehicle's DTC records are an event-driven summary of the raw diagnostics data, they still provide a wealth of information about the vehicle's historic state and performance.

This information can be a useful tool for a mechanic diagnosing a particular fault with a vehicle that has been brought in for repair. The starting point of the mechanic's diagnostic analysis tends to be a vehicle that has already developed an evident fault that requires repair, with the mechanic then working ‘backwards’ to diagnose the cause of that fault by (among other things) drilling down into whatever parts of extensive DTC records he or she considers relevant to the fault in hand. This is heavily reliant on the personal knowledge and expertise of the mechanic, and as such there will always be some subjective elements to his or her analysis.

The term “telematics” is sometimes used in this context as an umbrella term for diagnostics and monitoring. Telematics often has a geographic element, and can for example take the form of diagnostics data having associated location data, such as GPS or similar, which can be used to map a vehicles location over time together with any changes in its internal state as it travels. However, in its broadest sense, the term telematics as used herein can refer to any sensor or (other) diagnostics data collected by a vehicle's on-board data collection system, and is not restricted in this sense. That is, the terms telematics and diagnostics in relation to data are synonymous herein.

### SUMMARY

DTC events are one example of what are referred to herein as “diagnostic warning events”. A diagnostic warning event is an event captured in a vehicle's diagnostics data and which indicates a potential issue with the vehicle.

The present invention provides a mechanism for determining the relative significance of any given type diagnostic warning event (e.g. corresponding to a particular DTC). This is captured in a significance value that is assigned to at least one target diagnostic warning event type of interest. The significance value(s) is computed based on a systematic analysis of a vehicle diagnostics dataset in combination with a vehicle fault dataset, and provides an indication of the extent to which diagnostic warning events of the target type recorded in the diagnostics dataset are causally linked with vehicle fault events recorded in the vehicle fault dataset. That is, in the present context, the more significant diagnostic warning event types are the ones having stronger causal links with such vehicle fault events. For example, where the vehicle fault events recorded in the vehicle fault data set are repair events (i.e. corresponding to repair operations performed on the vehicles), the higher the significance value of a diagnostic warning event type, the greater the likelihood of the vehicle requiring repair should that type of diagnostic warning event occur.

The analysis is based on the assumption that diagnostic warning events and repair events are causally linked if they have associated timings that are within a predetermined time window of each other. This assumption has been tested and has proved to be effective.

A first aspect of the invention provides a computer-implemented method of predicting vehicle failures comprising: receiving, at a processing stage: i) a vehicle diagnostics dataset, which records historic diagnostic warning events for a population of multiple vehicles and an associated timing for each diagnostic warning event, and ii) a vehicle fault dataset, which records historic vehicle fault events experienced by at least some of the vehicles and an associated timing for each vehicle fault event, wherein the diagnostic warning events and vehicle fault events are associated in their respective datasets with cooperating vehicle identifiers; wherein a predictive algorithm executed at the data processing stage determines whether or not each diagnostic warning event of a target type is time-associated with a vehicle fault event in that its associated timing is within a predetermined time window relative to that of any vehicle fault event associated with a matching vehicle identifier, and computes, based thereon, a significance value for the target type of diagnostic warning event, the significance value denoting the likelihood of a vehicle fault event occurring should a diagnostic warning event of the target type occur.

One of the benefits of the invention is that it provides a basis for early fault detection and preventative vehicle maintenance: once a particular type of DTC event has been identified as significant, when a DTC event of that type is actually triggered in a working vehicle, that vehicle can be brought in for maintenance in response, in the knowledge that this particular DTC event is likely to imply a significant vehicle fault. This allows any such fault to be detected and corrected or mitigated sooner than would otherwise be possible, or even prevented altogether by way of this early response.

This predictive approach is essentially the opposite of the reactive analysis outlined in the final paragraph of the Background section, i.e. the invention is about predicting significant vehicle faults based on observed diagnostic warning events so that such faults can be corrected or mitigated early or prevented altogether though appropriate vehicle maintenance (predictive analysis), in contrast to diagnosing the cause of a significant vehicle fault after it has occurred based on the diagnostic event records leading up to that point (reactive analysis).

Diagnostic warning events can be detected by an on-board vehicle monitoring system but they can also be detected via external processing of raw diagnostics data obtained from the vehicle's data collection system. Diagnostic warning events can be detected and recorded in real-time, but this is not essential for the purposes of the present invention.

In the described examples, the vehicle fault events are repair events, i.e. corresponding to repair operations that were performed on the vehicles in question and recorded in the vehicle fault dataset, e.g. at a garage or other vehicle repair facility. However, the invention is not limited in this respect. For example, the vehicle fault events could be vehicle breakdown events; that is, vehicle breakdowns recorded in the vehicle fault data set, recorded for example by a roadside assistance service. In that case, significance is measured in terms of how likely a given type of diagnostic warning event is to be followed by a roadside breakdown event.

In embodiments, the predictive algorithm may compute the significance value for the target type of diagnostic warning event by comparing the number of diagnostic warning events of the target type that are time-associated with vehicle fault events with the number of diagnostic warning events of the target type that are not time-associated with any vehicle fault events

The method may comprise a step of configuring, based on the computed significance value, a vehicle alert component to trigger the outputting of an alert for a vehicle in response to the detection of a diagnostic warning event of the target type by an on-board diagnostics system of the vehicle.

The alert may be triggered in real-time in response to the detection of the diagnostic warning event.

The alert may be outputted to a user of the vehicle.

The method may comprise a step of controlling a display device to display, to a user of the display device, an indication of the target diagnostic warning event and the significance value assigned to it.

A processing component of the data processing stage may extract, from the vehicle fault dataset, repair information for the target diagnostic warning event type, and associate the extracted repair information with the target diagnostic warning event type, the repair information being information about at least one of the vehicle fault events that is time-associated with one of the diagnostics warning events of the target type.

The extracted information may comprise at least one of: a repair code, a repair frequency value, and a repair resource value.

The method may comprise controlling the display device to display the extracted information to the user of the display device.

The predictive algorithm may compute respective significance values for multiple target diagnostic warning event types.

The processing component may extract repair information from the vehicle fault dataset for each of the target diagnostic warning event types and associate it therewith.

The method may comprise: identifying at least one type of diagnostic warning event in a set of diagnostic data collected by an on-board data collection system of a vehicle; determining that the significance value assigned to the identified type of diagnostic warning event meets a significance criterion; and in response to that determination, performing a maintenance operation on the vehicle.

In performing the maintenance operation, a fault with at least one component of the vehicle may be identified and the identified component may be adjusted, repaired or replaced to correct or mitigate the fault.

The fault may be identified using the repair information associated with the identified diagnostic warning event type.

The method may comprise a step of determining an ordered list of at least some of the target diagnostic warning event types, which is ordered according to their respective significance values.

The method may comprise a step of determining a subset of the target diagnostic warning event types, each having a significance value that meets a significance condition.

The significance condition may be that the significance value exceeds a threshold.

The significance condition may be that the significance value is within a range of values.

The ordered list may be an ordered list of the subset of target diagnostic warning events.

The alert component may be configured to trigger the outputting of an alert for the vehicle in response to the detection of a diagnostic warning event of any of the subset of diagnostic warning event types.

The method may comprise determining a fault-associated vehicle count for the target diagnostic warning event type, which is a count of vehicles that have experienced a diagnostic warning event of the target type that is time-associated with a vehicle fault event.

The method may comprise a step of determining a fault-associated vehicles count for the target diagnostic warning event type, by counting vehicles that have experienced at least one diagnostic warning event of a type other than the target type, and which is time-associated with a vehicle fault event.

The fault-associated vehicles count may be a total fault-associated vehicles count, corresponding to the sum of the number of vehicles that have experienced at least one diagnostic warning event of the target type, which is time-associated with a vehicle fault event, and the number of vehicles that have experienced at least one diagnostic warning event of a type other than the target type, which is time-associated with a vehicle fault event.

The predictive algorithm may determine at least one vehicle fault prediction based on the significance value and a current interval of diagnostics data, the vehicle fault prediction relating to the number of vehicles expected to experience a vehicle fault event in a subsequent interval.

The method may comprise determining an aggregate significance value by aggregating the significance values across the subset.

The vehicle fault prediction may be determined for the subset of target diagnostic warning event types based on the aggregate significance value and the current interval of diagnostics data.

The predictive algorithm may determine the number of diagnostic warning events of the target type that are time-associated with vehicle fault events and at least one of: the number of diagnostic warning events of the target type that are not time-associated with vehicle fault events, and the total number of diagnostic warning events of the target type, in order to perform the comparison.

The significance value may be a probabilistic value, denoting the conditional probability of a vehicle experiencing a fault event given that it has experienced a diagnostic warning event of the target type.

The probability value may be estimated as a ratio of the number of diagnostic warning events of the target type that are time-associated with vehicle fault events and the total number of diagnostic warning events of the target type.

The vehicle fault dataset may be a vehicle repair dataset and the vehicle fault event may be vehicle repair events.

The vehicle fault dataset may be formed of warranty claim records.

The vehicle fault dataset may be a vehicle breakdown dataset and the vehicle fault events may be vehicle breakdown events.

The vehicle diagnostics dataset may be determined from a larger vehicle diagnostics dataset, by extracting, from the larger diagnostics dataset, diagnostics data for vehicle identifiers associated with matching vehicle attributes, such that the significance value is specific to a vehicle attribute or set of vehicle attributes.

Another aspect of the invention provides a computer-implemented method of predicting machine failures comprising: receiving, at a processing stage: i) a machine diagnostics dataset, which records historic diagnostic warning events and an associated timing for each diagnostic warning event, and ii) a machine fault dataset, which records historic machine fault events and an associated timing for each machine fault event, wherein the diagnostic warning events and machine fault events are associated in their respective datasets with cooperating machine identifiers; wherein a predictive algorithm executed at the data processing stage determines whether or not each diagnostic warning event of a target type is time-associated with a machine fault event in that its associated timing is within a predetermined time window relative to that of any machine fault event associated with a matching machine identifier, and computes, based thereon, a significance value for the target type of diagnostic warning event, the significance value denoting the likelihood of a machine fault event occurring should a diagnostic warning event of the target type occur.

Another aspect of the invention provides a computer-implemented method of predicting vehicle faults, the method comprising implementing, at a data processing stage, the following steps: receiving diagnostics data collected from a plurality of vehicles; receiving vehicle fault data recording fault events experienced by at least some of the vehicles, each vehicle fault event having an associated timing; for each of the vehicles, determining a significance label for at least one piece of diagnostics data collected that vehicle, the significance label indicating whether or not that vehicle has experienced a fault event within a prediction window; and using the pieces of diagnostics data and their significance labels to make a vehicle fault event prediction for a target piece of diagnostics data.

In embodiments, the receiving step may comprise receiving the diagnostics data and associated timing data collected from a plurality of vehicles, and the prediction time widow may be defined relative to a timing associated with the piece of diagnostics data.

The pieces of diagnostics data and their significance labels may be used to train a predictive component, executed at the data processing stage, to learn causal associations between pieces of diagnostics data and vehicle fault events, wherein the vehicle fault event prediction is outputted by the trained predictive component based on the target piece of diagnostics data.

The vehicle fault event prediction may comprise a significance value for the target piece of diagnostics data, denoting the likelihood of a vehicle fault event occurring within the prediction window given the target piece of diagnostics data.

The significance value may denote the likelihood of a vehicle fault event occurring within the prediction window as defined relative to a timing associated with the target piece of diagnostics data.

Each piece of diagnostics data may be a portion of diagnostics data collected within a history window.

The history window may have a fixed length.

The history window may have a variable length. For example, the history window length for each portion of diagnostics data may be provided as an input to the predictive component.

Each piece of diagnostics data may be in the form of an individual diagnostics warning event.

The method may comprise: processing each of the pieces of diagnostics data to generate a set of summary data therefrom, wherein the predictive component is trained using the sets of summary data and the associated significance labels; and processing the target piece of diagnostics data to determine a set of summary data therefrom, wherein the vehicle fault event prediction is outputted by the trained predictive component based on the set of summary data determined from the target piece of diagnostics data.

Each set of summary data may comprise one or more diagnostic warning event counts.

The diagnostics data received at the data processing stage may comprise a sequence of diagnostic warning events.

The diagnostics data received at the data processing stage may comprise raw diagnostics data.

The method may comprise a step of performing an analysis of the diagnostics data independently of the vehicle fault data, wherein the determining step and/or the using step are performed in dependence on the analysis.

The analysis may comprise at least one of the following: a statistical analysis, an unsupervised machine learning analysis, and a topological data analysis.

The predictive component may be trained by optimizing a function of the significance labels and the output of the predictive component during the training. The function may be optimized by iteratively adapting model parameters of the predictive component based on the significance labels and the output of the predictive component during the training.

Each significance label may indicate whether or not that vehicle has experienced a fault event within the prediction window.

Each of the vehicle fault events may be associated with a resource value and each significance label is determined based on the resource value associated with any vehicle fault event experienced in the prediction window, wherein the vehicle fault prediction may comprise a predicted resource value for the prediction window.

The method may be performed in real-time.

Another aspect of the invention provides a computer-implemented method of predicting vehicle faults, the method comprising implementing, at a data processing stage, the following steps: receiving diagnostics data collected from a plurality of vehicles; receiving vehicle fault data recording fault events experienced by the vehicles; for each of the vehicles, determining, for at least one piece of diagnostics data collected from that vehicle, a significance label based on the vehicle fault data for that vehicle; and using the pieces of diagnostics data and their significance labels to make a vehicle fault event prediction for a target piece of diagnostics data.

The method may comprise: determining that the vehicle fault event prediction meets a significance criterion; and in response to that determination, performing a maintenance operation on the target vehicle. For example, that a significance value of the prediction exceeds a significance threshold. In performing the maintenance operation, a fault with at least one component of the target vehicle may be identified and the identified component may be adjusted, repaired or replaced to correct or mitigate the fault.

Each fault event may have been identified by manual inspection of the vehicle or machine in which it occurred.

Another aspect of the invention provides a data processing stage comprising: electronic storage configured to store computer readable instructions; and one or more processors coupled to the electronic storage and configured to execute the computer readable instructions, the computer readable instructions being configured, when executed on the one or more processors, to implement any of the methods or system/device functions disclosed herein.

Another aspect of the invention provides a computer program product comprising computer readable instructions stored on a computer readable storage medium and configured, when executed at a data processing stage, to implement any of the methods or system/device functions disclosed herein.

Reference is made to United Kingdom patent application, filed by the Applicant on 27 Mar. 2018 and having the title “Vehicle Telematics” and Application No. 1804886.8 (the 410036 GB application), which is incorporated herein by reference in its entirety.

Each set of summary data referred to above may comprise one or more driving style parameters.

The set of one or more driving style parameters can be determined in the manner disclosed in the 410036 GB application. That document discloses how the set of driving style parameters can be determined from vehicle telematics data (diagnostics data), e.g. average speed, maximum acceleration, total brakes per journey, etc., for each vehicle in a population of vehicles. In accordance therewith, this may comprise determining, for each piece of diagnostics data: i) a feature object by processing that piece of diagnostics data to determine at least one driving style parameter therefrom, the feature object comprising the at least one driving style parameter, and ii) a training label (significance label) for the feature object based on one or more of the vehicle fault events associated with that vehicle identifier. The driving style parameters can for example comprise at least one of: a total number of journeys, a total number of days, a number of journeys per day, a time per journey, a journey time per day, a moving time per journey, a moving time per day, a distance covered per journey, a distance covered per day, an average speed, a maximum speed, an average moving speed, a maximum moving speed, an average acceleration, a maximum acceleration, an average deceleration, a maximum deceleration, a total number of brakes per journey, a total number of brakes per day, an average engine revolutions per minute (RPM), a maximum engine RPM, an average engine RPM during acceleration, a maximum engine RPM during acceleration, an average engine RPM at constant speed, and a maximum engine RPM at constant speed.

### BRIEF DESCRIPTION OF FIGURES

For a better understanding of the present invention, and to show how embodiments of the same may be carried into effect, reference is made to the following figures in which:

FIG. 1 shows a schematic block diagram that is generally representative of a modern vehicle;

FIG. 2 shows a schematic block diagram of a data processing stage configured to assign significance values to DTCs;

FIG. 3 shows a timeline-based illustration of some of the principles of the method;

FIG. 3A shows a timeline-based illustration of the mechanism by which a repair-associated vehicles count is computed;

FIG. 4 shows a user interface on which a selection of DTC codes is ordered according to volume;

FIG. 5 shows a user interface on which a selection of DTCs ordered according to significance values;

FIG. 6 shows a user interface operating in a validation mode;

FIGS. 7 and 8 show a user interface on which DTCs in a probability group are rendered, sorted according to significance and total vehicles respectively;

FIGS. 9 to 11 show a user interface on which repair codes associated with a selected DTC are rendered, sorted according to volume, rate and cost respectively;

FIGS. 12 to 14 show a user interface on which repair codes associated with a particular DTC are rendered, sorted according to volume, rate and cost respectively, for a later set of data;

FIG. 15 shows a schematic block diagram of a vehicle alert system, which is configurable based on the results of the predictive analysis; and

FIG. 16 illustrates an example of how a probabilistic classification model may be trained to make vehicle fault predictions; and.

### DETAILED DESCRIPTION

Embodiments of the invention are describe in detail below. First, some useful context to the invention is provided.

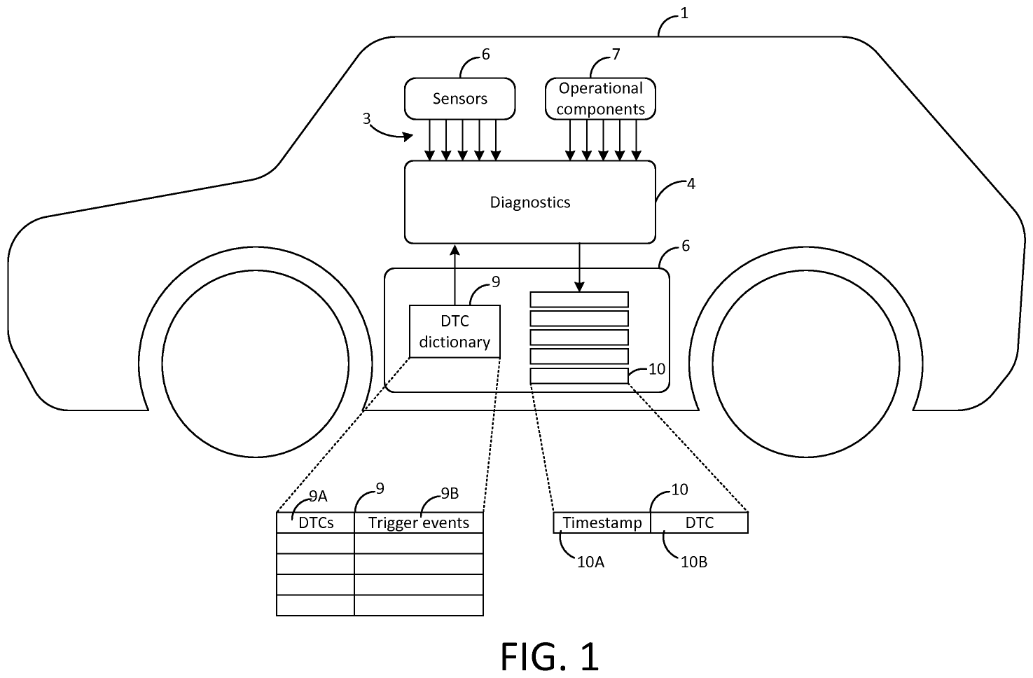

FIG. 1 shows a highly schematic block diagram that is generally representative of a typical modern vehicle 1 having OBD functionality. The vehicle 1 is shown to comprise an OBD system 4 having access to on-board electronic storage 6. The OBD system 4 can be a functional component of the vehicle 1 representing OBD functionality implemented by the vehicle's on-board computer system.

The OBD system 4 collects various diagnostics data, as represented by the set of inputs labelled 3, and applies a diagnostic analysis to the collected data 3 in order to generate summarized diagnostics data. The diagnostics data 3 collected by the OBD system 4 comprises raw diagnostics data collected from on-board sensors 6, which are coupled to the OBD system 4 and can arranged to monitor essentially any desired property of the vehicle 1 or its various subsystems and components. The OBD system 4 can also be coupled to other on-board data sources of the vehicle 1, such as other operational components 7 (physical or software) of the on-board computer system, and the diagnostics data 3 can comprise data collected from such sources, e.g. data about errors that have occurred within the on-board computer system.

In this example, the on-board diagnostic analysis is DTC-based and uses DTC definition data 9 held in the electronic storage 6. The DTC definition data 9 comprises a predetermined set of DTCs 9A and associated triggering parameters. The triggering parameters 9B are selected based on engineering knowledge and expertise. When an event is detected in the diagnostics data 3 that meets the triggering parameter(s) associated with a particular DTC (DTC event), according to the terminology used herein, this triggers the associated DTC. The OBD system 4 creates a record 10 of the triggering event in response, which comprises the associated DTC (labelled 10A) and a timestamp of the triggering event 10B.

The set of event records created over time as DTCs are triggered constitutes a summarized diagnostics dataset, which provides an overall record of which DTC codes have been triggered at which times.

Examples of the various factors to which the DTCs in the set 9 may relate are given above, in the Background section. As noted therein, there may be hundreds or thousands of different DTCs in the set 9, relating to many different aspects of the vehicle's performance. Separating more significant DTCs from less significant ones is therefore not a straightforward task.

As indicated above, the invention provides a systematic mechanism for determining the relative significance of different types of DTC (or other diagnostic warning) event, using a time-based model of causal links between DTC events and vehicle repair events. The example embodiments described below are DTC event-based, but the description applies equally to other forms of diagnostic warning event. In the context of DTC codes, each DTC corresponds to a particular DTC event type.

Embodiments of the invention will now be described by way of example only. As noted above, although the following is described with reference to vehicle repair events, the description applies equally to other types of vehicle fault event. That is, the description applies equally to other forms of vehicle fault data set and not just vehicle repair datasets.

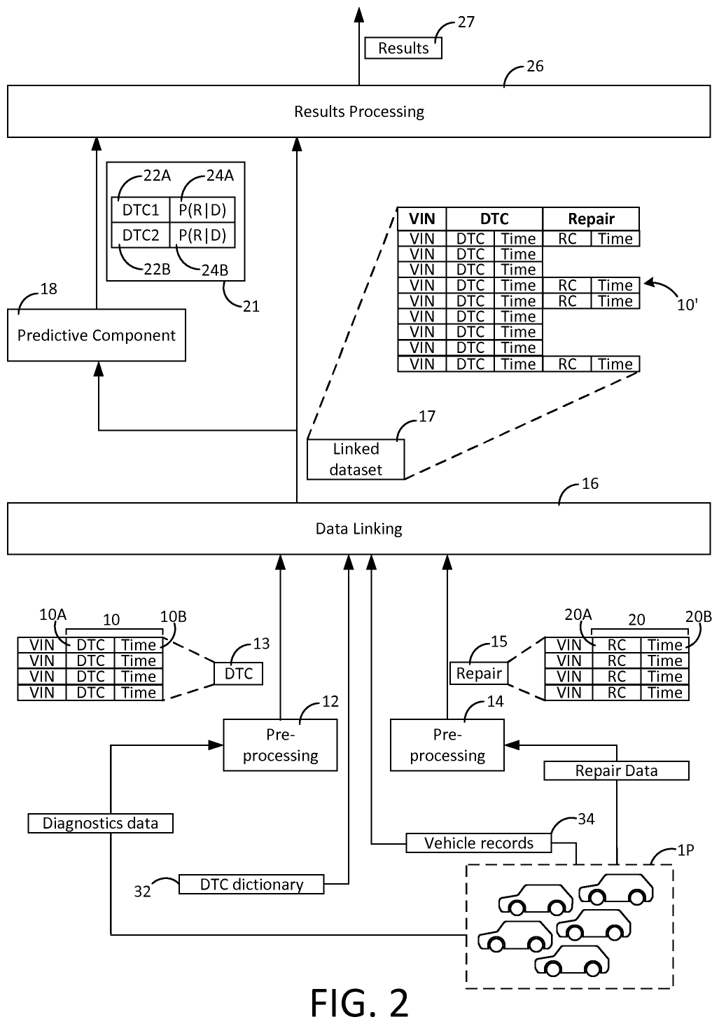

FIG. 2 shows a schematic block diagram of a processing stage, shown to have a diagnostics data pre-processing component 12, a repair data pre-processing component 14, a data linking component 16, a predictive component 18 and a processing component 26. These components 12-18 are functional components of the data processing stage, i.e. they represent functions that are carried out according to computer-readable instructions (software) executed on one or more processing units of the data processing stage (such as CPUs, GPUs etc.).

Although not shown in FIG. 2, the system also comprises electronic data storage, in which the final and any intermediate results can be stored in an accessible fashion.

As described in detail below, the predictive component 18 applies a predictive analysis to a combination of diagnostics and vehicle repair data, in order to assign a significance value to each DTC within a set of DTCs of interest (target DTCs), which are outputted as results 21 of the predictive analysis. The analysis is performed according to a predictive algorithm executed at the data processing stage. Purely by way of example, FIG. 2 shows first and second target DTC codes 22A, 22B to which first and second significance values 24A, 24B have been assigned. However, as will be appreciated, the analysis can be performed for any number of target DTC codes, and it may be desirable to apply it for a much larger set of target DTC codes in some contexts.

The data linking component 16 receives, as inputs, a diagnostics dataset 13 for a population of vehicles 1P for which the analysis is being performed, and a vehicle repair dataset 15 for the same population of vehicles 1P.

Each vehicle within the set is uniquely identified by a vehicle identifier (ID), in the form of a vehicle identification number (VIN). As is known in the art, a VIN is a unique code that is used to identify an individual vehicle throughout its life.

The repair dataset 13 is shown to comprise a set of DTC records 10 of the kind described above with reference to FIG. 1, each of which is associated with a VIN and records a DTC event that occurred in the corresponding vehicle of the population 1P. As described above, each DTC record 10 comprises a DTC code 10A and an associated timing 10B, which corresponds to a time at which that DTC was triggered in the vehicle in question in this example.

The diagnostics dataset 15 is shown to comprise a set of repair record(s) 20, each of which is associated with a VIN, and records at least one repair operation performed on the corresponding vehicle in the population 1P. Each repair record 20 comprises a timing value 20B. This can correspond to the time at which the repair operation was actually performed, but this is not essential—it could for example be a later time at which the repair record 20 was processed, and this can still be used to give reliable results. In this respect, it is noted that where this description refers to the time at which an event occurs, the relevant description applies more generally to the timing associated with that event.

The repair records 20 can be in the form of warranty claim records. One of the realizations underpinning the described techniques is that, within a predetermined window of a vehicle's “lifetime” (the warranty period), comprehensive data about component faults/failures within that widow is available to the manufacturer. This is because, during that time window, whilst the vehicle is still under warranty, it is the manufacturer who bears the responsibility for such failures/repairs.

Each repair record 20 is shown to comprise at least one repair code (RC) 20A relating to the type of repair operation(s) that was performed as part of the repair event. The RC can for example be a labour operation (LOp) code, identifying a type of labour operation performed, or part code of a faulty vehicle component identified in the repair. Whilst such information can be used to refine the analysis that is performed, it is not in fact essential for the purposes of the invention for the repair record 20 to identify the type of repair; embodiments of the invention can be implemented using only the associated timing information 10A.

In this example, the datasets 13, 15 are generated by the pre-processing components 12, 14 applying any necessary pre-processing to, respectively, data diagnostics and vehicle repair received at the data processing stage to place them in a form that allows them to be used in the manner described below. This can for example include the removal of duplicate or erroneous records, re-formatting, reformulation of DTC codes etc. As will be appreciated, the level of pre-processing required will depend on the state of the initial data, and pre-processing may be omitted if the data is received in a sufficiently refined form.

Although not show in FIG. 2, depending on the size of the data sets, an extra pre-processing stage might be required where the data sets are stored in a distributed database and need to be collated together. For real-time analytics, the appropriate software and database structure will be in place for both storage and the predictive elements.

The respective VINs contained in the diagnostics and vehicle repair datasets 13, 15 cooperate in that they allow repair operations recorded in the repair dataset 13 to be matched to corresponding DTC records for the same vehicle in the diagnostics dataset 15. A function of the data linking component 16 is to link the repair record(s) 20 associated with each VIN in the repair dataset 13 to the corresponding set of DTC records 10 associated the matching VIN in the diagnostics dataset 13, based on time-windowing.

The linking is performed such that DTC records are only linked to repair records for the same VIN. In this particular example, the linking is time-based and is performed by comparing the timing values of the repair records with the timing values of the DTC records. For each DTC record 10 in the diagnostics dataset, the data linking component 16 determines whether the timing value 10B of the DTC record 10 is within a predetermined time window (ΔT) relative to the timing value 20B of any repair record 20 associated with the same VIN. That is, it determines, for each DTC event 10, whether there exists any repair event 20 such that those events' associated timings (10B and 20B respectively) are within ΔT of each other.

As will become apparent, this time-based linking is geared towards particular forms of predictive model. In general, the function of the data liking component is to link diagnostics and vehicle fault data for the same vehicle. The precise nature of the linking can be tailored to the model in question. In some cases, it may be more appropriate to create a single linked record for each vehicle containing all of its diagnostics and fault data of interest (for example).

According to the terminology used herein, when a repair event and a DTC event do satisfy this time-windowing criterion, those events are said to be “time-associated” (or simply “associated”). A “repair-associated DTC event” means a DTC event that is time-associated with at least one repair event. Such events are assumed to be causally linked according to the model adopted herein. By contrast, a “non-repair-associated DTC event” means a DTC event that is not time-associated with any repair event, and such events are assumed to have no causal link according to the present model. Repair-associated and non-repair-associated DTC records mean records of repair-associated and non-repair-associated DTC events respectively.

The term “fault-associated” has the same meaning as repair-associated, but applies more generally to other types of vehicle fault events.

Using the terminology of the preceding paragraphs, the above-described function of the data linking component 16 can be equivalently stated as one of classifying each DTC event as repair-associated or non-repair-associated.

In the following examples ΔT is one month. This has been found to be a suitable window, though there is some flexibility in this respect. If ΔT is too long or too short, that may affect the quality of the results, however as will be appreciated this is context dependent and what constitutes too long or too short in any given content will be apparent to the skilled person in light of the teaching presented herein.

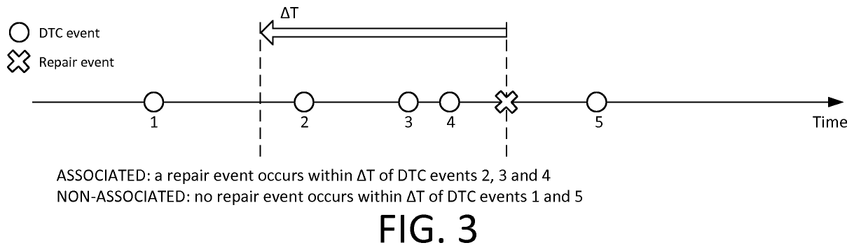

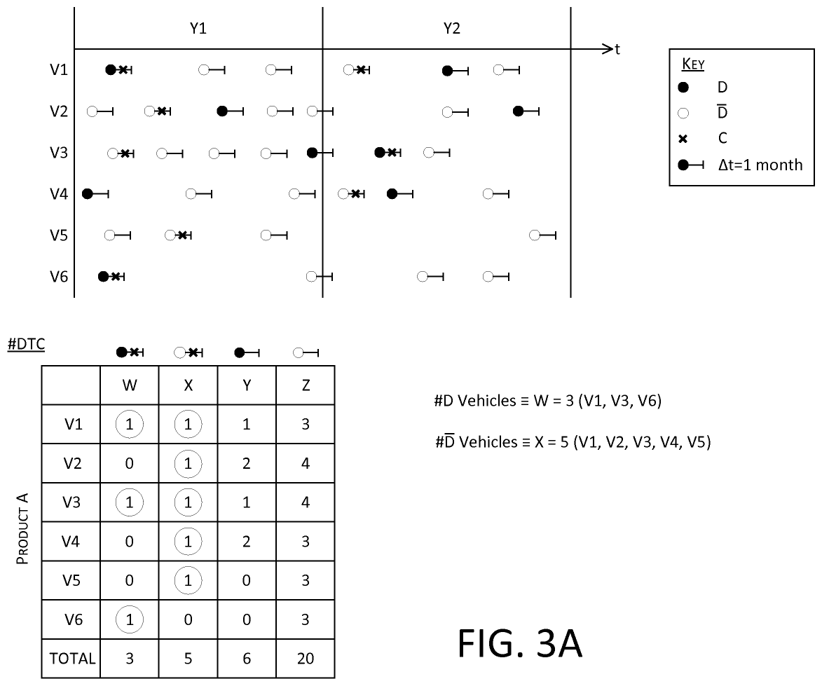

The underlying time-windowing concept is illustrated by way of example in FIG. 3. In this simple example, five DTC events are represented circles on a timeline (labelled 1 to 5), at positions corresponding to their associated timings. A repair event is represented by a cross on the timeline, at a position corresponding to its associated timing. DTC events 2, 3 and 4 are time-associated with the repair event because the repair event occurs within ΔT of each of these; whereas DTC events 1 and 5 are non-repair-associated DTC events because no repair event occurs within ΔT of these.

The result of the linking is a linked dataset 17, which incorporates each DTC record 10 of the diagnostics dataset 13, and in which repair-associated DTC records are distinguished from non-repair-associated DTC records.

In order to facilitate additional analysis, the data linking component 16 may also identify, for each repair-associated DTC event, the one or more repair events it is associated with. For instance, the linked dataset 17 in the example of FIG. 2 is formed of augmented DTC records 10′ (each corresponding to one row of the linked dataset 17). Each augmented DTC record 10′ corresponds to one of the DTC records 10 of the repair dataset 13 but augmented, where applicable, with data of any of the repair records 20 with which it is time-associated, such as its constituent repair code(s) 20A and associated timing 20B. This additional information can be useful when performing additional analysis as described later, because it allows significant DTCs to be tied to specific types of repair event. However, will be apparent in view of the following, this additional information may not be needed depending on the extent of the additional analysis (if any). Indeed, as will become apparent, whilst this intermediate linking step is a useful optimization that can provide a performance benefit, it is not essential to create a linked dataset 17, as the predictive analysis that is applied by the predictive component 18 can be applied to the diagnostic and vehicle repair datasets 13, 15 directly, as will be apparent in view of the following.

In the example of FIG. 2, the data linking component is also shown having an input to receive vehicle records 34 relating to the population of vehicles 1P. These can be records that are created when each of the vehicles commenced active service. By matching the VINs to VINs of the vehicle records 34, the data linking component can additionally augment the records of the linked dataset 18 with vehicle data derived therefrom, although this is not shown explicitly in FIG. 2.

The vehicle records 34 can be sales records created when the vehicles are sold. Sales records are a convenient instrument for collecting comprehensive data about vehicles commencing active service, however any suitable form of vehicle records 34 can be used.

It is noted that, whilst vehicle records 34 relate to the same population of vehicles 1P, they are generally collected at different times than the repair and diagnostics datasets 15, 13 from different (sometimes disparate) sources. The use of VINs in these datasets makes this possible, as it allows the disparate records to be linked.

In some practical contexts, the DTC records of the diagnostics dataset 13 may be extracted as part of the repair events recorded in the repair dataset 15. Thus DTC records may, in practice, only be available for vehicles that have experienced such repair events. A benefit of the methodologies taught herein is that they give reliable results even when the data is limited in this manner.

The data linking component 16 is also shown having an input to receive one or more DTC dictionaries 32, which can be used to match DTC codes across different “domains”, to ensure that DTCs across different domains are handled consistently by the system, e.g. to equate similar DTCs across different standards or manufacturer-specific DTCs across different manufactures. As will be appreciated, there is unlikely to be an exact one-to-one correspondence across difference domains, and creating the appropriate dictionary(ies) 31 may involve a degree of human judgement. Although shown as an input to the data linking component 16, this could in fact be part of the pre-processing depending on how it is implemented.

Bayesian Model

A particular DTC-level Bayesian model is described first (extensions to other models, both DTC-level and vehicle-level models, are described later). This model uses counts of DTCs associated with a repair and counts of DTCs associated without a repair as the input features. The probabilities are generated using Bayes rule:

Pr(Claim|DTC)=(Pr(DTC|Claim)*Pr(Claim))/Pr(DTC)

Where:
Pr(Claim|DTC)=W/(W+Y);
Pr(DTC|Claim)=W/(W+X);
Pr(Claim)=(W+X)/(W+X+Y+Z);
Pr(DTC)=(W+Y)/(W+X+Y+Z);

And:
W is a count of a DTC events of a specific target type (D) that result in, i.e. are time-associated with, a warranty claim (C), within a summary time window (focussing time period) over which the data is considered (e.g. two years);
X is a count of all other types of DTC event (D̅) in the focusing time period that also result in a claim (C);
Y is a count of DTC events of the target type (D) in the focusing time period and resulting in no claim (C̅);
Z is the count of all other types of DTC event (D̅) in the focusing time period that results in no claim (C̅).

This is summarized in the following table:

| | DTC | No DTC | Total |
|---|---|---|---|
| Claim | W | X | W + X |
| No claim | Y | Z | Y + Z |
| Total | W + Y | X + Z | W + X + Y + Z |

In the specific model that will now be described:
Each vehicle has a two year summarised window plus one month for the case that the a DTC fires at the end of the two year window;
For a single vehicle, with n distinct DTCs fired in the two year window, there will be n 2×2 matrix of counts;
For DTCs that have fired more than once in the summarised window, these are aggregated to one 2×2 matrix of counts;
After the counts have been calculated, each vehicle level DTC 2×2 matrix of counts is aggregated to a global 2×2 matrix of counts. The total vehicles in this global matrix will include only vehicles that have experienced that specific DTC.

The result is a model for each global DTC matrix, all with various total vehicle counts, so that when a DTC fires on a vehicle, it outputs the probability of a failure.

Significance Values—P(R|D):

As indicated above, the predictive analysis applied by the predictive component 18 assigns a significance value 24A, 24B to each target DTC 22A, 22B. The significance value denotes the likelihood that a vehicle will actually require repair in the event of the target DTC being triggered in that vehicle.

In the following, the significance value is an estimate of a conditional probability P(R|D), that is, the probability of a repair event (R) occurring for a vehicle given that the target DTC (D) has been triggered for that vehicle. (It is noted in this respect that the term “likelihood” as used herein is use in accordance with its everyday meaning, and not in the specific statistical sense of a likelihood function).

The probability P(R|D) can be computed efficiently based on simple counting of repair-associated and non-associated DTC records comprising the target DTC, in accordance with equation (1):

$$P ( R \vert D ) = \frac{w}{w + y}$$

where w is the total number of repair-associated DTC records the linked dataset 18 comprising the target DTC in, and y is the total number of non-repair-associated DTC records the linked dataset 17 comprising the target DTC.

As can be seen, the greater the proportion of the total number of DTC events of that type that time-associated with (i.e. within ΔT of) a repair event, the greater their significance according to the metric of equation (1).

More precisely, because of the way it is calculated with respect to the time window Δt, P(R|D) is the probability of a repair event occurring with an associated timing in the interval [t, t+ΔT] given that a DTC event of the target type has occurred with an associated timing t. The interval [t, t+ΔT] is a prediction window as that term is used herein, whose timing is defined relative to the timing of the DTC event.

Where the counts are determined with respect to any type of repair event, P(R|D) denotes the probability of any type of repair event occurring given that D has occurred.

However, the same methodology can be applied that to particular types or classes of the repair event. For example, separate probabilities P(R₁|D), P(R₂|D) can be computed for each target DTC (D) for different types or classes of repair event R₁, R₂, using respective counts w₁, w₂ which are counts of repair events associated with repair events of the first and second types or classes of repair event R₁, R₂ respectively (ignoring associations with other types/classes of repair event).

As will be appreciated, y does not need to be computed to evaluate equation (1) (though it can be); this is because x+y could be evaluated directly by simply counting all DTC events (repair-associated and non-associated).

A benefit of the significance value of equation (1) is that it accounts for the fact that the most significant DTC events are not necessarily the most frequently occurring DTC events. This can be illustrated with a simple example: one of the most frequently triggered DTC in vehicles are low fuel-type DTCs, which are triggered when the fuel level in a vehicle drops below a threshold. However, in the vast majority of cases, these are not indicative of a problem with the vehicle that means it needs repair. There may be a relatively large number of low-fuel DTC events that are time-associated with repair events (because they are common), but these will not be classed as particularly significant because these will only be a relatively small proportion of the total number of such DTC events.

The computation represented by equation (1) is one way of comparing the number of repair-associated DTC events (w) of the target type (as defined by the target DTC) with the number of non-associated DTC events (y). Fundamentally, it is this comparison that provides the benefits set out in the preceding paragraph: if only a small proportion of DTC events of a particular type are repair-associated with repair events, those DTC events are unlikely to carry any significant implications in terms of required vehicle repairs even if they occur frequently; whereas if a relatively large proportion of DTC events of a particular type are repair-associated, those DTC events are much more likely to imply the need for vehicle repair when the occur, even if they occur relatively infrequently. As will be appreciated, this comparison can be performed in other ways, to obtain a significance value that captures the relevant information.

The processing component 26 processes the results 21 generated by the predictive analysis (i.e. the predictive output 22 of the predictive component 18), together with the linked dataset 17 where necessary, in order to generate output results 27 for outputting to a user of the system. These results can be outputted to a user on a display device, via a user interface (UI) rendered on the display device.

In the examples described below, broadly speaking, the processing component 26 performs at least two functions.

The first function is sorting and aggregating the target DTCs based on their P(C|D) values.

The second function is extracting respective repair information for each of the target DTCs, and associating the respective repair information with that DTC. This goes beyond the simple counting of time-associated DTC events described above. The repair information is extracted from the records of the individual repair events that are time-associated with the individual DTC events of the target type (so if there are, say, twenty DTC events of the target type recorded in the diagnostics dataset 13, which are time-associated with a total of fifteen repair events in the repair data 15, then the repair information for the target DTC is extracted from the records of those fifteen repair events). This can be conveniently extracted from the linked dataset 17.

The extracted repair information for a given DTC, together with its P(C|D) value, tells the user not only how likely that DTC event is to imply a repair event, but also what the nature of that repair event might be, given the nature of the repair events that are causally linked with that type of DTC event historically.

Vehicle Attributes:

The P(C|D) values do not necessarily need to be computed across the whole vehicle population 1P; different P(C|D) values can be computed for a given DTC type D for different sub-populations having common vehicle attributes. That is, for different “variants”.

A “variant” in this context refers to a vehicle attribute or set of vehicle attributes, wherein all vehicles having that/those attribute(s) are considered to be of that variant. That is, a variant is a type of vehicle defined by one or more vehicle attributes. A variant could for example be all vehicles of a particular manufacturer (“OEM”), brand, product, model (any model year), model and specific model year or years etc., or all vehicles with a particular model or class or engine or transmission system etc. The system can operate on different levels and classes of variant.

For each of the vehicles in the population 1P, its relevant vehicle attribute(s) can be determined, using the associated vehicle record 34 where necessary. Subpopulations of the vehicles, corresponding to different variants, can then be determined by grouping them according to their vehicle attributes, and the analysis described above can be applied to each subpopulation to determine a set of P(C|D) values for different DTCs for each subpopulation. In this case, the conditional probability may be represented using the following notation:

P(C|D,V)

That is, as the probability of a claim event C given that a DTC event of type D has occurred in a vehicle of variant V, and the value may differ between different variants because certain DTCs may have different levels of significance for different variants.

Output Results:

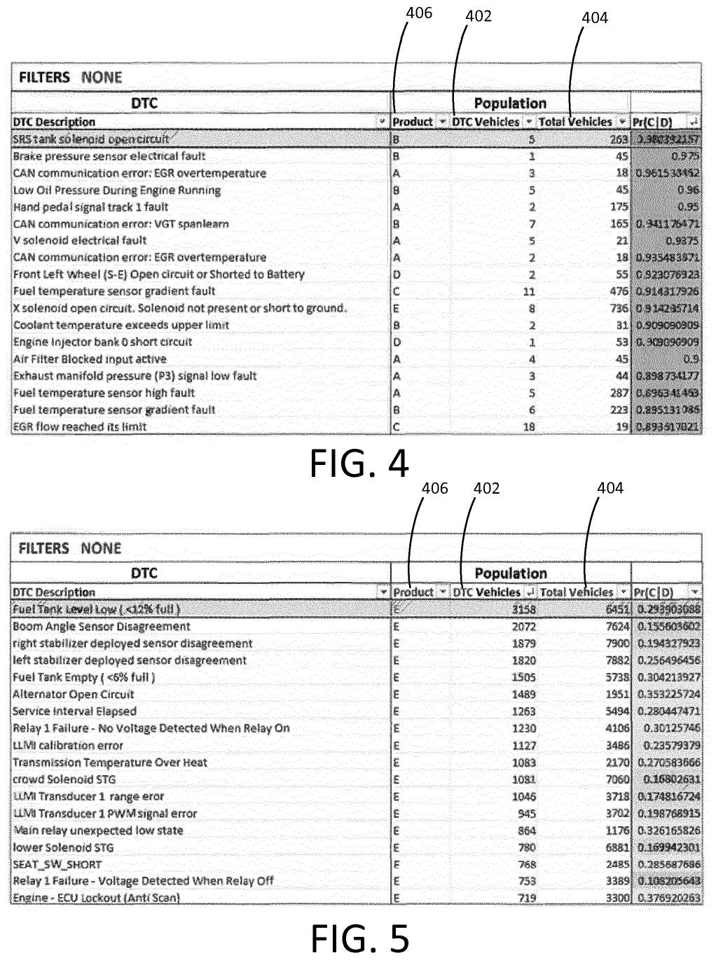

Various examples of the types of output results 27 that can be generated and rendered via the UI will now be described with reference to FIGS. 4 to 14.

In these examples the repair records are in the form of warranty claim records. That is, records created when a repair is performed under warranty as part of the processing of the warranty claim. Hence, in FIGS. 4 to 14, and the following description, the notation P(C|D) is used, denoting the probability of a warranty claim (C) given D. The term claim in the following refers to warranty claim unless otherwise indicated.

However, as will be appreciated, the description applies equally to other forms of vehicle repair record.

FIG. 4 shows an example of how the target DTCs may be ordered according to P(R|D) in the output results 27, such that the DTCs that have the most significance implications for vehicle repairs, i.e. those with the highest P(R|D), are displayed first.

For comparison, FIG. 5 shows a selection of DTCs ordered by “volume”; that is according to “DTC vehicle values” 402.

According to the terminology used herein, a “repair-associated vehicle” means any vehicle that has experienced a repair event that is recorded in the vehicle repair dataset 15; a “DTC vehicle” for a target DTC means a repair-associated vehicle that has triggered the target DTC within ΔT prior to a repair event. That is, which has experienced at least one repair-associated DTC event of the target type.

The DTC vehicle value for each DTC is a count of DTC vehicles for that DTC. So in FIG. 5, there are three thousand one hundred and fifty eight (3158) DTC vehicles for “Fuel Tank Level Low (<12% full)” DTC, and two thousand and seventy two (2072) repair-associated vehicles that have triggered the “Boom Angle Sensor Disagreement” DTC etc. It might be assumed that the DTCs with the highest DTC vehicle values are the most significant because those are the DTCs that are most commonly triggered in vehicles that are associated with a repair event. However, this ignores the fact that many of the most common DTCs, such as those relating to fuel level (such as the two Fuel Level DTCs visible in FIG. 5), will be triggered relatively frequently not only in repair-associated vehicles but also in vehicles that are not, as noted above.

FIG. 4 also shows P(C|D) values and FIG. 5 also shows DTC vehicle values 402 for their respective DTCs. As can be seen, DTCs with the highest P(C|D) values—i.e. those for which associated claim events are most probable—are not the ones with the highest DTC vehicle values and vice versa. This is because, unlike the DTC vehicle values, the P(C|D) values do encapsulate the distinction between DTCs that are causally linked with claim events (according to the present model) and DTCs that are simply common.

In FIGS. 4 and 5, a product column 406 is also shown, and in these examples the P(C|D) values are specific to the product subpopulation as identified in column 406 (one of products A through E in this example). This more granular analysis allows the significance of particular DTC codes to be determined for particular products (more generally, different variants), and the relative significance of a given DTC may be different for different variants, as noted.

Both FIG. 4 and FIG. 5 also show “total vehicles” values (counts) 404 for each of their respective DTCs. As explained below, the total vehicles count for a particular DTC in this context is not the same as the total number of vehicles in the population 1P and generally varies for different DTCs, as is evident in FIGS. 4 and 5.

This is to do with the time-based nature of the analysis, which considers the number of VINs that experience a DTC-Claim in ΔT from the trigger date of individual DTCs. So, the monthly windows under consideration—e.g., for a particular carline (or other variant)—will vary for each DTC type, which in turn leads to a varying Total Vehicle count.

The total vehicles count for a given DTC is computed as the sum of the DTC vehicle count for that DTC and a “non-DTC vehicles” count for that DTC.

A non-DTC vehicle for a target type of DTC event (i.e. a target DTC) means a vehicle that has experienced at least one repair associated event of a type other than the target type. Some of the consideration behind this will now be explaines.

The notation introduced above is used below where appropriate: DTC events of the target type are denoted without bars (˜D) whereas DTC events of other types are denoted with bars (˜D̅).

With reference to FIG. 3A, when counting D̅ type events, this is done across the summary window, which is the whole period of time for the training dataset, e.g. 2 years, in this example, in order to compute the counts (W,X,Y,Z) defined to above. These counts can be aggregated up any desired variant level.

Essentially, DTC vehicles are those that comprise the W set and non-DTC vehicles are those that comprise the ‘X’ set. That is, a vehicle can be both a DTC vehicle and a non-for a given target DTC. This can be thought of as sampling with replacement.

This is illustrated by way of example in FIG. 3A, which shows respective timelines of DTC and repair events for six vehicles V1-V6 over a two year summary window. In FIG. 3A, D-type DTC events are shown as black circles, whereas a-type DTC events are shown as white circles. Claim events are represented by crosses, and the respective prediction windows (of duration ΔT) are marked for the DTC events.

In FIG. 3A, as can be seen, vehicle V6 is a DTC vehicle, vehicles V2, V4 and V5 are non-DTC vehicles, and vehicles V1 and V3 are both DTC and non-DTC, for the target DTC in question.

The total vehicles count is computed for the target type of DTC event as a sum of the DTC vehicles count and the non-DTC vehicles count. As will be apparent, generally this will be lower than the total number of vehicles in the population 1P. The reason the total for a particular variant may be different for different DTCs is because a single vehicle may find itself in both the DTC set and the non-DTC set.

In the example of FIG. 3A, for this particular target DTC, the DTC vehicles count is three (˜402 in FIGS. 4 and 5) and the non-DTC vehicles count is five, giving a total vehicles count of eight for that DTC (˜404 in FIGS. 4 and 5).

The Total Vehicles count 404 may also be referred to as a total repair-associated vehicles count, as it is a count of vehicles that have experienced repair-associated DTC events (of any type) within the specific set of time windows [symbol] . The total vehicles count provides an indication of the overall activity across the population. The purpose of this metric is to give an idea of how prevalent the in question DTC is.

The total repair-associated vehicles count 404 is a useful metric because it captures targeted information about the DTC-claim activity across the vehicle (sub)population.

Where the Total Vehicles count 404 is significantly higher than the DTC vehicles count 402 for a given target DTC (e.g. as for the “SRS tank solenoid open circuit” DTC at the top of FIG. 4), this indicates that there were a relatively large number of repair-associated DTC events of other types occurring across the (sub)population. Conversely, where the total repair-associated vehicles count 404 is close to the DTC vehicles count 402 for a particular target DTC (such as the “EGR flow reached its limit” DTC at the bottom of FIG. 4), this indicates that there were a relatively small number of repair-associated DTC events of other types occurring across the (sub)population.

The DTC vehicles count 402 is also a repair-associated vehicles count as that term is used herein, but one which excludes the vehicles that have experienced repair-associated DTC events of the target type.

In the above, the DTC and non-DTC counts have been defined as functions of an individual target DTC. However, the definition can be extended to a set of target DTCs. With a set of DTCs, a vehicle is a DTC vehicle if it has experienced at least one repair-associated DTC event of at least one of the target types, and the set ID becomes the set of all repair-associated DTC events of the target types. Accordingly a vehicle is a non-DTC vehicle if it not a DTC vehicle and has experienced a repair-associated DTC event of a different type (i.e. not in the target set of DTC types) within ΔT of any of the events in [symbol] .

Moreover, these values need not be computed across the whole population of vehicles 1P. Like the P(C|D) values, the DTC and non-DTC vehicles counts can be computed on a per-variant basis. That is, over the subpopulations of the vehicles determined based on vehicle attributes, in the manner described above. Thus the DTC, non-DTC and total vehicles counts can be not only DTC specific, but also specific to particular variant, such as product, make, model, model-plus-model year etc.

Returning to FIGS. 4 and 5, in these examples, the DTC and total vehicles counts values 402 and 404 are specific not only to the DTC in question but also to the specific product identified in column 406.

These counts have various uses, examples of which will now be described.

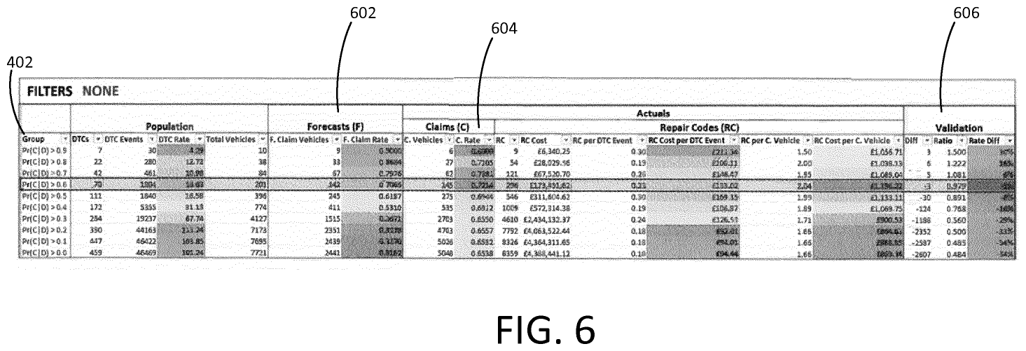

FIG. 6 shows a table of values and illustrates the first function of the processing component 22, which is that of aggregating the set of target DTCs by probability.

In the example of FIG. 6, this is based on thresholds. Ten groups are defined, based on uniformly spaced probability thresholds and all DTCs having P(C|D) values that meet the threshold for a given group are assigned to that group (such that most DTCs are assigned to multiple groups. The thresholds in this example are 10% probability thresholds, i.e. 0.0, 0.1, 0.2, 0.3, 0.4, 0.5, 0.6, 0.7, 0.8 and 0.9, and the group with threshold p is denoted >p. So, for example, P(C|D)=0.34 appears in groups >0.0, >0.1, >0.2, >0.3.

Another option is to aggregate by probability range. For example, in mutually exclusive groups defined by 10% probability ranges, such as (0,0.1], (0.1, 0.2], (0.2,0.3], . . . , (0.9-1.0].

Grouping the target DTCs in this way, and organizing the output results 27 based on the assigned groupings, has a number of benefits. One is to facility navigation of those results 27 in a way that is intuitive from an engineering perspective, and therefore allows issues to be isolated reliably and efficiently. Examples of such group-based navigation are described later. Another benefit is to facilitate validation the P(C|D) values, as will now be described.

Validation:

For the purposes of validation, some of the available data is set aside as testing data, in contrast to the data used to compute the counts and probabilities (the training data).

In this example, two years' worth of training data is used for a population of vehicles and an assessment is made of what happens in windows of 1 month from any occurrence of a DTC event, at any time during that 2 years, for all vehicles. The aggregated counts W, X, Y, Z are used to generate probabilities for each DTC type.

When a DTC occurs on a vehicle in a testing dataset at any time during the 1 month of coverage, that vehicle is assigned the probability of experiencing a claim associated with the DTC fired that was calculated in the training set.

The training set will get bigger as time goes on, i.e. it can span longer than 2 years (in fact, the more time covered, the better). The counts and derived probabilities will be updated on a rolling basis and applied to current data to forecast the upcoming month.

FIG. 6 shows a set of validation values 606 that form the basis of the validation in this example. Each of those values relates in this example to one of the >p probability groups, each of which corresponds to one row of the table in FIG. 6.

The validation values are based on a comparison of forecast claim activity, captured as forecast values 602 which are 602 derived from the P(C|D) values for the DTCs in the group in question, and actual claim values 604.

There are two corresponding forecast values 602: forecast claim vehicles (in the column headed “F. Claim Vehicles”) and forecast claim rate (in the Column headed “F. Claim Rate”), which are computed as follows.

F. Claim Vehicles (expected fault vehicles count): Forecasted number of vehicles that will likely experience a claim in the following month for the selected group. This is computed using the DTC data 13 that is available for the current month [t₀−ΔT, t₀]. For example, where ΔT is a month, using a recent month's worth of data. It is computed as:

F. Claim Vehicles=total vehicles*F. Claim Rate

That is, as the product of a total vehicles count for the group and the forecast claim rate computed for that group. Note that the “total vehicles” value here is not the repair-associated vehicles count defined above and shown in FIGS. 4 and 5—rather, in this context, it is simply a count of vehicles corresponding to the probability group, i.e. the number of vehicles in the population (or subpopulation, e.g. corresponding to a particular variant) that have triggered at least one of the DTCs in the group in question at some point in the current month [t₀−ΔT, t₀]. That is, it is simply the number of distinct vehicles that have experienced at least one occurrence of the particular DTC within the month under consideration. There is no need to exclude vehicles that have already experience a subsequent claim in the current month. Instead vehicles that have had any subsequent claim are considered, and the method attempts to draw out the causality by examining the associated repair codes.

F. Claim Vehicles is the expected number of those vehicles that will experience a claim event in the next month [t₀, t₀+ΔT]. That is, the total number of vehicles that have triggered at least one of the DTCs in the group in question in the current month and are expected to experience a claim in the next month.

F. Claim Rate: This is derived by aggregating the P(C|D) values across the applicable group.

The aggregation is performed as follows:
1. DTC event is fired,
2. DTC (+associated vehicle and any claims) is placed into a probability group according to the probability associated with that particular DTC that has been generated from the training data,
3. P(C|D)*num. vehicles per group=num. forecast claim vehicles,
4. Num. forecast claim vehicles/total num. vehicles=forecast claim rate

There are two actual claim values 604: claim vehicles count (C. Vehicles) and claim rate (C. Rate), computed as follows:

C. Vehicles: This is computed for validation purposes from the data for the time interval [T_{cutoff}, T_{cutoff}+ΔT]. So if ΔT is one month, it is computed using the next month's worth of data. It is the number of vehicles in the group that actually experience a claim that time interval, e.g. in the following month.

There are three validation metrics 606, computed as follows:
Diff: difference between F. Claim Vehicles and C. Claim Vehicles for the group in question, F. Claim Vehicles−C. Claim Vehicles
Ratio: ratio of F. Claim Vehicles and C. Claim Vehicles for the group in question, F. Claim Vehicles/C. Claim Vehicles
Ratio Diff: difference between F. Claim Rate and C. Claim Rate for the group in question, F. Claim Rate−C. Claim Rate (expressed as a percentage in FIG. 6).

By way of example, consider the >0.7 probability group in FIG. 6.

It can be seen in the Total Vehicles column that 84 vehicles have experienced a DTC in the >0.7 group (i.e. a DTC with P(C|D)>0.7) in the month in question. A claim rate of 0.7976 has been derived by aggregating the P(C|D) values for the DTCs in the >0.7 probability group (F. Claim Rate). It is therefore forecasted that 84*0.7976≈67 of those 84 vehicles will experience a claim in the following month (F. Claim Vehicles).

Turning to the Claims column 604, it can be seen that in reality 62 of those 84 vehicles experienced a claim in the following month (C. Vehicles), giving an actual claim rate of 62/84≈0.7381 (C. Rate).

The difference between the F. Claim Vehicles and the C. Claim Vehicles values for the >0.7 probability group is therefore 5 (Validation; Diff value), and the ratio of those values is 67/62≈1.081 (Validation; Ratio). The difference between the F. Claim Rate and the C. Claim Rate values is 0.7976−0.7381≈0.06=6%. These metrics allow the accuracy of the forecasts for the group in question to be assessed in different ways.

Other information about the population and the actual claims corresponding to each group can also be provided, as shown in FIG. 6. The table immediately below provides an explanation of each of the additional values given in the Population and Actuals sections of FIG. 6.

Population

| | |
|---|---|
| DTCs | The number of DTCs in the group in question. |
| DTC events | The total number of times that DTCs in the group |
| | in question have been triggered in the relevant |
| | interval. |
| DTC rate | DTC rate = DTC events/DTC. |

Actuals

| | |
|---|---|
| RC | Number of repair codes recorded for the C. |
| | Vehicles, in the repair data. That is, the number |
| | of actual repair operations performed on the |
| | vehicles that have actually experienced claims in |
| | the following month for the group in question. |
| RC Cost | Total cost of the aforementioned repair |
| | operations - which is a reasonably reliable |
| | indicator as to their severity. |
| RC per DTC Event | Average number of repair codes per DTC Event, |
| | i.e. RC/DTC events. |
| RC Cost per DTC | (RC per DTC event * RC cost)/RC; a measure |
| Event | of the average cost per occurrence of a DTC in |
| | the group in question. |
| RC per C. Vehicle | RC/C. Vehicles |
| RC Cost per C. | RC Cost/C. Vehicles |
| Vehicle | |

Group-Based Navigation:

Grouping the output result 27 according to probability in this way allows those results to be navigated intuitively (from an engineering perspective), such that a user can pinpoint issues quickly. The navigation structure is hierarchical, in that it allows the user to focus on a particular one of the groups, and within that group, prioritise DTCs of interest.

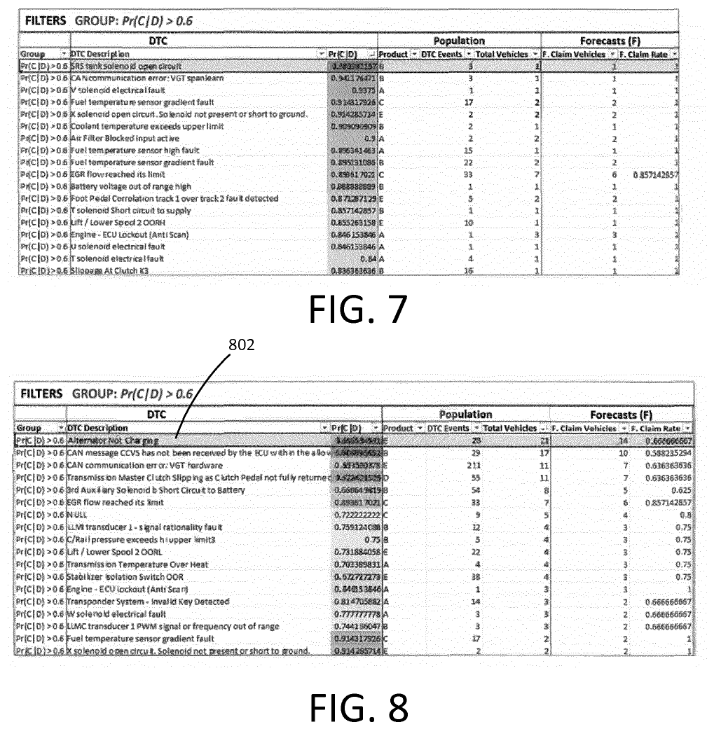

This is described with reference to FIGS. 7 to 14, which illustrate how the output results 27 can be rendered on a display. These can be provided within a hierarchical user interface (UI) structure, where the user can navigate between different pages of the UI as described below.

FIGS. 7 and 8 show members of the >0.6 group sorted according to P(C|D) and according to volume, which in this context means according to the “F. Claim Vehicles” value.

In FIGS. 7 and 8, the following metrics are defined in essentially the same way as FIG. 6: DTC Events, Total Vehicles, F. Claim Vehicles and F. Claim Rate, but on the level of individual repair codes rather than at the level of repair code groups, as per the following table:

| | |
|---|---|
| DTC events | Number of times the DTC in question has been |
| | triggered in the current month [t₀ − ΔT, t₀]. |
| Total Vehicles | Total number of vehicles that have triggered the DTC |
| | in question in the current month [t₀ − ΔT, t₀]. |
| F. Claim Vehicles | Expected number of those vehicles that will |
| | experience a claim event in the next month [t₀, t₀ + |
| | ΔT], computed as P(C\|D) * Total Vehicles |
| F. Claim Rate | F. Claim Vehicles/Total Vehicles |

Note that, whereas in the group analysis of FIG. 6, F. Claim Rate is derived by aggregating the P(C|D) values of the group in question and F. Claim Vehicles is derived from the resulting value, on the level of individual DTCs, it is the other way round: F. Claim Vehicles is computed directly from the Total Vehicles value and P(C|R), and F. Claim Rate is derived from the results.

As can be seen in FIG. 8, in this example, the DTC code that has the highest F. Claim Value in the >0.6 probability group is “Alternator Not Charging”, labelled 802.

With the DTCs in the group sorted in this way, the user can select any one of the DTCs in that group to focus on.

Selecting one of the DTCs in the group provides repair code data for the selected DTC. Every repair-associated DTC is associated with a set of one or more repair codes, which is formed of all repair code for the repair event(s) with which that DTC is time-associated. In the linked dataset 17 of FIG. 2, this is the set of all unique repair codes (RCs) across all augmented DTC records 10′ containing that DTC.

Extracting and providing this information in a meaningful way is part of the second function of the processing component 26.

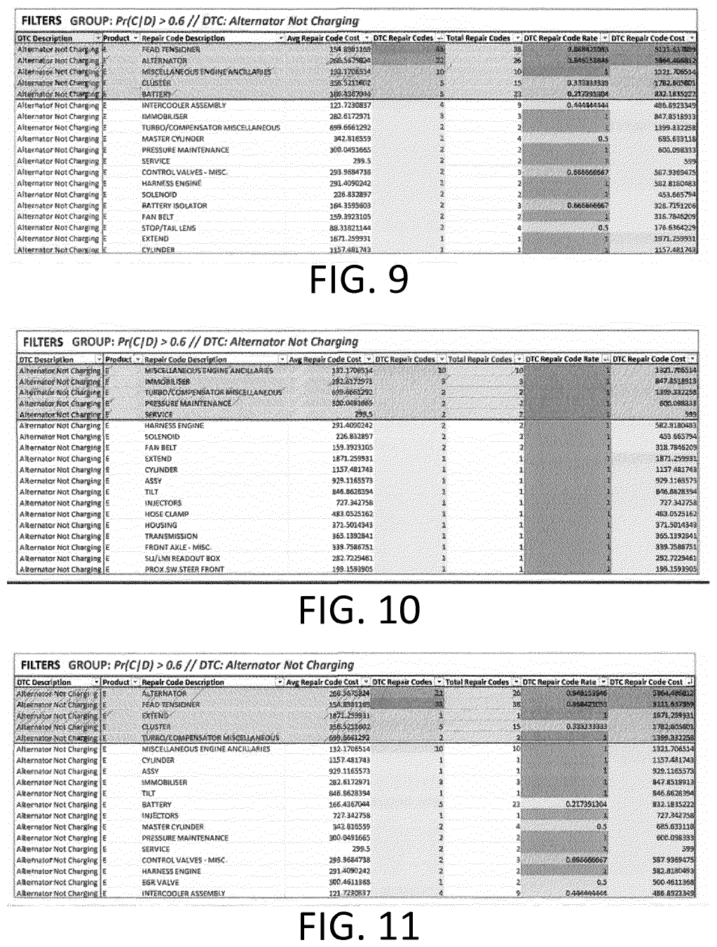

FIGS. 9 to 11 show examples of repair codes associated with the “Alternator Not Charging” DTC, which can be obtained by selecting that DTC 802 in the results of FIG. 8.

The fields shown in these figures and in later figures are defined in the following table:

| Field: | Relates to: | Definition: |
|---|---|---|
| DTC Repair | A particular | A count of occurrences of that RC in the |
| Codes | DTC-repair | repair dataset 15 that are time-associated |
| | code (RC) | with occurrences of that DTC in the |
| | pairing | diagnostics dataset 13 (e.g. if there are a |
| | | total of five repair records that comprise |
| | | that RC and occur within ΔT of a DTC |
| | | record comprising that DTC, the DTC |
| | | Repair Codes Value is five). |
| Total Repair | A particular | The total number of recorded occurrences |
| Codes | RC | of that RC in the repair dataset 15. |
| DTC Repair | A particular | [DTC repair codes]/[Total Repair codes], |
| Code Rate | DTC-RC | i.e. the number of occurrences of that RC |
| | pairing | that are time-associated with occurrences |
| | | of that DTC, as a proportion of the total |
| | | number of occurrences of that RC. |
| Avg Repair | A particular | Average cost (resource value) associated |
| Code Cost | RC | with that RC - which is a reasonably |
| | | reliable indicator as to its severity. |
| DTC Repair | A particular | [Avg Repair Code Cost]*[DTC Repair |
| Code Cost | DTC-RC | Codes] - estimate of the total cost of all |
| | pairing | occurrences of that RC that are time- |
| | | associated with occurrences of DTC. |

The RCs associated with the “Alternator Not Charging” DTC are shown sorted according to DTC Repair Codes, DTC Repair Code Rate and DTC Repair Code Cost in FIGS. 9, 10 and 11 respectively. These are different sorting options the user can select between via the UI, based on whatever aspect they are prioritizing (frequency or cost of associated repair operations, broadly speaking).

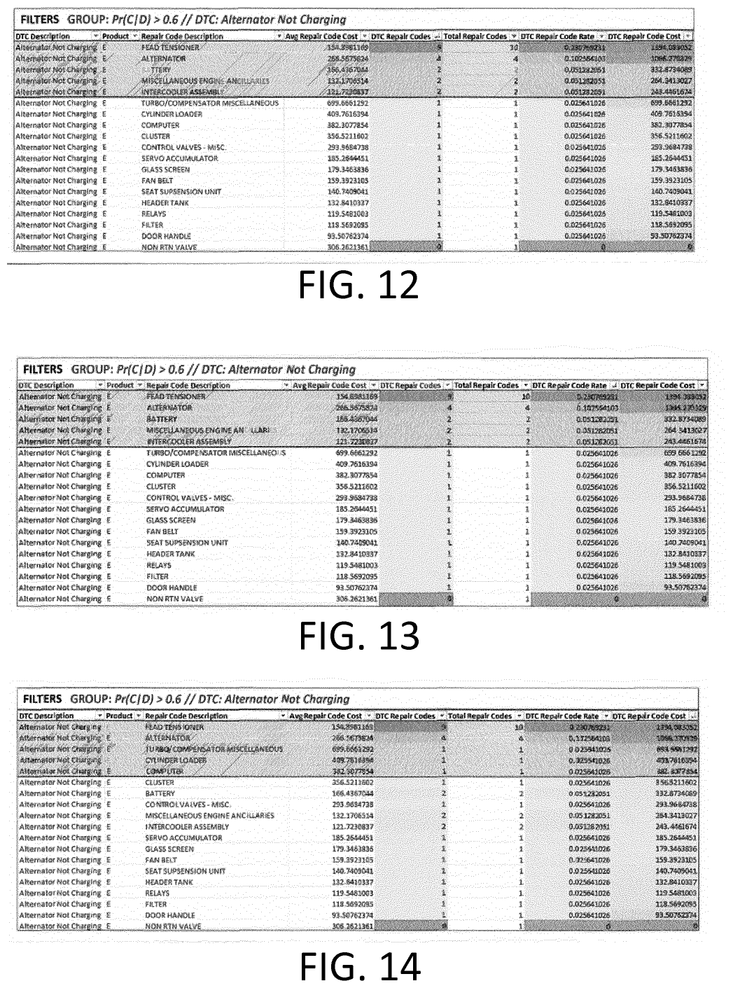

FIGS. 12 to 14 correspond to FIGS. 9 to 11 respectively, but for later data that has been collected. This could for example be after preventative maintenance has been performed. Here, a user can check whether the preventative maintained that was performed has been effective. If it is effective, this should be apparent from the new results.

Ultimately, this allows a user to understand not only which DTCs are causally linked with repair events, but also the nature of the repair events causally linked with particular DTC events. It also allows him or her to prioritize DTCs in the target group based on the volume or cost of associated repairs that are expected.

In summary, in accordance with the above, it is possible to obtain a prioritized list of causal DTCs that are responsible for vehicle failure, and from there a prioritized list of associated repair codes with an indication of frequency and cost impact.

Preventative Maintenance:

A benefit of this DTC-based approach is that it allows preventative maintenance to be performed on a per-vehicle basis, based on that vehicle's DTC history. For example, where it can be seen that an individual vehicle has been triggering a particular DTC with a relatively high P(C|D) values, preventative action can be taken to try and identify and fix whatever issue with the vehicle is causing that DTC to be triggered. This can take into account the information about the specific types of repair operation that have been associated with that DTC historically (such as type, frequency and/or cost) as in the above examples.

In other words, this allows issues with individual vehicles to be detected earlier than would otherwise be the case. This in turn allows any necessary repair/replace operations to be scheduled in advance in an appropriate manner, e.g. alongside other panned maintenance work or during normal operational hours, with less vehicle downtime (as opposed to those repair/replace operations being driven by vehicle breakdown, as might otherwise be the case, for example).

To take an extreme example, if a particular DTC with a P(C|D) value of more than 0.95 is triggered, there is a 95% chance that the vehicle has developed or will develop a fault significant enough to lead to a warranty claim within time ΔT. Whereas before such faults might not have been picked up until they actually caused vehicles to fail, with the invention vehicles triggering that DTC can be brought in for preventative maintenance in response, with only a 5% false positive rate expected. By detecting the issue earlier, at the very least, this allows a maintenance operation to be scheduled for the vehicle at a convenient time (rather than having to perform maintenance in response to the failure), and in some cases, if a fault can be detected earlier it may be less burdensome to repair.

Where the P(C|D) value is variant-specific, different types of preventative maintenance can be focussed on different variants where appropriate, to target the DTC that are most significant for specific variants.

Real-Time Alerts:

One possible way of driving preventative maintenance is to provide an early-warning system based on real-time alerts driven by a vehicle's DTC activity, that can be used in conjunction with a OBD-capable vehicle of the kind described with reference to FIG. 1.

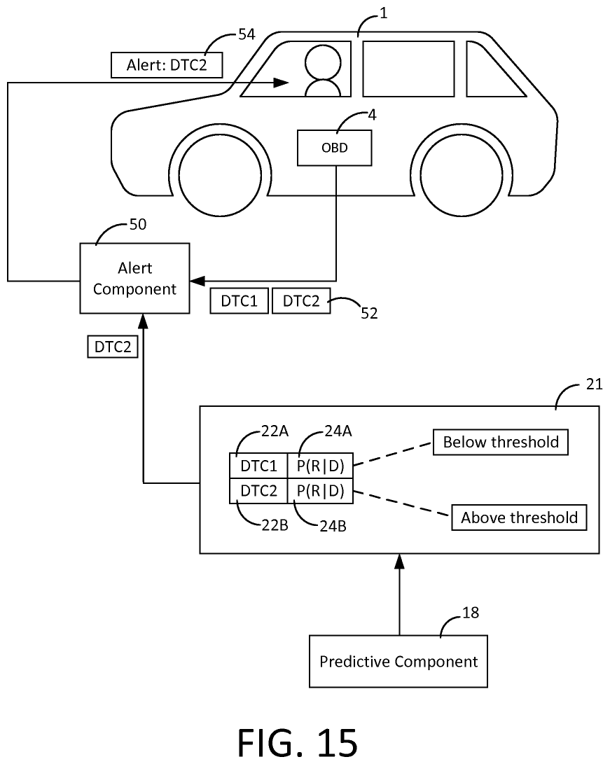

FIG. 15 shows a schematic block diagram corresponding to this use case, in which real-time alerts are selectively generated based on the results 21 of the predictive analysis. In this simple example, an alert component 50 is configured, based on the results 21, to be responsive to DTCs for which P(R|D) is above a threshold (only). The alert component 50 is communicatively coupled to the OBD system 4 of the vehicle 1 for receiving triggered DTCs. When a DTC to which the alert component 50 is responsive is triggered (DTC2, for which P(R|D) is above the threshold), the alert component 50 generates an alert 54 in response. The alert 54 is generated and outputted to a user of the vehicle 1 in this example, for example via the vehicle's dashboard. By contrast, when a DTC to which the alert component 50 is not responsive triggered (DTC1, for which P(R|D) is below the threshold), the alert component 50 does not generate an alert.

The P(R|D) can be the value that is specific to the variant of the vehicle 1, such as the product group, product, model, model-plus-model-year etc.

The alert component 50 can be implemented within the vehicle 1 itself, or it can be a remote component that the vehicle communicates with wirelessly, for example.

As will be appreciated, this simple thresholding is just one example of how the alert component 50 can be configured using the results 21 of the predictive analysis. The criteria according to which the alert component 50 is configured based on the DTC significance values 24A, 24B can be more refined than this. The alert component 50 can be configured automatically using the results 21, but there may be a degree of manual oversight (for example, in selecting the rules according to which the alert component 50 is configured based on the significance values 24A, 24B).

The benefit of this approach is that the user is only alerted to triggered DTC that (in this example) imply a sufficiently high probability of the vehicle 1 requiring repair.

In other cases, the alert could be outputted elsewhere, not necessarily to the driver (e.g. it could be outputted to a vehicle fleet operator or manager), and need not be outputted in real-time.

Extensions:

As noted, the above is a Bayesian model, based on simple counts of DTC events. This has the advantage of being efficient to implement. However, the principles can also be applied with other models, such as logistic regression models, neural networks, and tree-based algorithms.

Before considering further specific extensions to other models, it is useful to consider the general steps involved from receiving the telematics and claims data sets and arriving at an end solution, which could be real-time or not.
1. Telematics data and claims data received. They may be stored in the same database or have separate databases depending on size of data, etc. The telematics data sets could be sensor readings and/or diagnostic trouble codes. The columns in the telematics data sets will have similarities between each company but will not be a predetermined set of columns.
2. At this stage, without any linkage between the telematics and claims data, it is possible to do various types of data analysis such as statistics, unsupervised machine learning, topological data analysis, etc. If the data is large enough that it needs to be stored in a distributed database, an extra layer of complexity exists to be able to do the analysis, as the data needs to be collated from multiple sources. Similarly if the analysis is in real-time.
3. Linking the data sets provides telematics history on vehicles and information on whether or not the vehicles/parts experience a failure or not, and their respective costs. This opens up the possibility of predicting if a vehicle/part will experience a failure or not using techniques such as supervised machine learning.
4. When building models using supervised ML, extra features may be crafted from the original columns in the telematics data sets together with external data. Each algorithm will have different input features requirements e.g. DTC counts for Bayes, sequences for RNNs (recurrent neural networks), etc. For predicting vehicle failure, the output variable (which is a training label, referred to herein as a “significance label”) could be:
   a. binary e.g. failure within a month or not
   b. multiclass e.g. failure within various time intervals
5. Once the model is built, has achieved acceptable performance, the model can be deployed to predict vehicle failure on new, unlabelled data. Again, this could be real-time or daily/weekly updates, etc.
6. The model may be re-trained, and this could be offline or online training/learning.
7. Displaying the analysis and predictive results, a front-end which displays the results may be provided.

That is to say, in general, a significance value can be assigned by the trained model to an unlabelled portion of vehicle diagnostics data. The significance value indicates how significant it is in terms of its expected consequences with regards to vehicle fault events. The model is trained using equivalent but labelled pieces of vehicle diagnostics data, where the significance label to it captured what the relevant consequences, in terms of vehicle fault events, actually were for that portion of data.

For each vehicle in the training population, at least one portion of diagnostics data collected from it is assigned a significance label, which is determined in dependence on any vehicle fault event experienced by that vehicle within a prediction time window. That is, based on any vehicle fault data available for that vehicle within the prediction time window. The prediction time window can be defined relative to the portion of diagnostic data in question.

The piece of diagnostics data could be a single DTC event (or similar) event that is labelled as associated not associated with a DTC event, as in the Bayesian model described above. Alternatively, it could be a longer section of DTC/sensor history over a history interval, which could also be combined with other inputs (such as vehicle attributes, window length etc.) and/or assigned more detailed labels relating to different prediction windows.

As will be appreciated, the precise nature input features and the labels will vary depending on the model used.

The Bayesian model described above is specific implementation, where the model is built at the DTC-level: each piece of diagnostics data corresponds to an individual DTC event, and the significance label assigned classifies it as repair-associated nor not repair-associated. This model effectively says “a DTC has been fired on this vehicle, and based on all other examples in the trained model, this DTC firing has a probability x that this vehicle will experience a failure in the described time window”.

An alternative model, built at the vehicle level might say: “based on the features the model has been built on, which could be multiple factors including counts of DTCs, etc., this vehicle is being classified (through some significance value, which may or may not be probabilistic or other) as going to experience a failure in the described window”.

The significance label could be continuous, rather than a binary or multiclass classification. One example of this would be when considering cost, i.e. where the training data is labelled based on repair cost and the prediction is a predicted cost.

In short, the sensor/DTC data gives a snapshot of a training vehicle, and the claims data allows the outcome to be labelled. What varies between each model is the input features, the algorithm that the model uses to classify, and the output metric that decides the classification result. What these models have in common is that, once configured, they allow some vehicle predictions to be made from unlabelled diagnostics data for a particular prediction time window—e.g. whether or not the vehicle will experience a vehicle fault event (of a specific type(s) or of any type) within the prediction window, the likelihood of a vehicle fault event within the prediction window, the expected costs of vehicle fault events over the prediction window etc.

Extensions—DTC-level:

Depending on how it is implemented, it may also be possible to implement the method in real-time, such that the significance values are computed and updated in real-time (rather than on, say, monthly cycles).

Logistic Regression can be formulated to be to be Pr(Y=y|X=x) where y is the vehicle failing, or not, and x is the input feature space. This could be extended to neural networks where appropriate activation functions are used e.g. ReLu or Sigmoid.

With such machine learning (ML)-based approaches, a model is trained to learn an output function y(x), given a set of training input vectors (x₀, . . . , x_{N}) together with the intended values of the output function (y₀, . . . , y_{N}) for those input vectors (the training data). In other words, the model is provided with some ‘examples’ of input-output vector pairings as training data from which it can generalize. Here, each xₙ training vector could for example capture a snapshot of the DTC history for a particular VIN over an interval of length ΔT, and yₙ would indicate whether or not that DTC history snapshot xₙ is considered repair-associated, based on temporal proximity with a repair event (or lack thereof). Depending on the internal logic of the model, the assignment of significance values to individual DTCs may be an inherent part of the training (e.g. the significance value could be a weighting assigned a particular DTC that is adapted during training, such as a logistic regression coefficient or neural network weighting), or the model could be used to assign significance values to individual DTCs once trained.

A tree-based method may use a threshold to decide where a DTC should be “bucketed”. The resulting model would have a rank of significant features in classifying a vehicle fault event. The significance value could for example be a bucket index assigned to a given DTC events (with different buckets corresponding to different levels of significance), or some other significance value assigned by the model.

This is an example of how other ML models can be used to build a DTC-level model, i.e. in which significance values are assigned to individual DTCs. Vehicle-level models are considered later.

Also, although the above considers individual DTCs, the method could be sequence based. In that case, a diagnostic warning event may be a particular sequence of DTCs rather than an individual DTC (say), or in other words a form of “meta-DTC” built on top of the basic DTC definitions. This is still a DTC-level model, at the level of meta-DTCs.

Extensions—Vehicle-Level:

As noted, the techniques can also be extended to vehicle-level models.

Training a model at the vehicle level results in a significance value of the vehicle experiencing a failure or not, and does not necessarily assign a significance value to a particular DTC. Under-the-hood, the significance value could have been derived from multiple factors and/or meta DTCs (including sequences of DTCs).

For example, a “snapshot” of vehicle's sensor and/or DTC history, within a time window of interest (summarized window), can be summarized and then classified whether or not it experiences a failure in the following time period e.g. 1 month.

The summarized window can be pre-defined, but need not be and in some cases, the windows could be input features. For example, the windows could have a variable duration where the duration of the window is an input feature.

As another example, the duration of the window could be a function of usage (e.g. mileage), e.g. the prediction window could correspond to a pre-determined change in mileage, such that its duration depends on the level of usage experienced by a vehicle.

ML Example—Probabilistic Classification

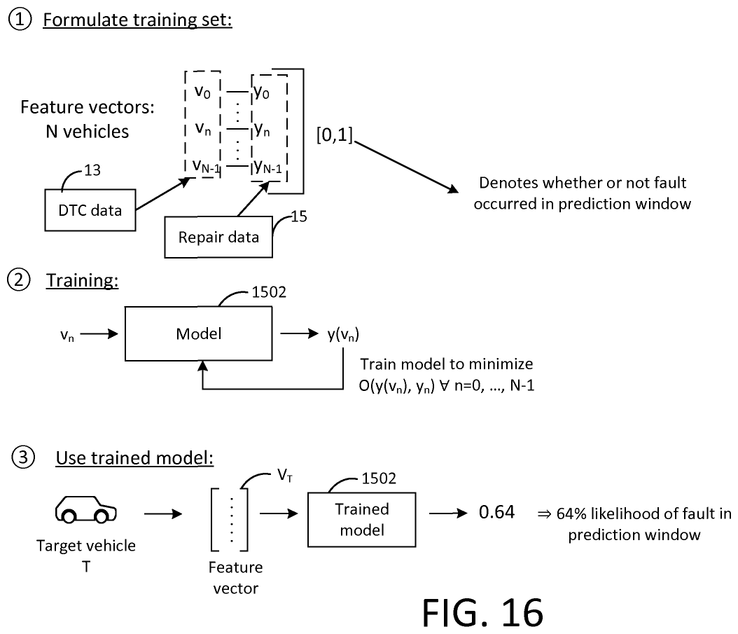

FIG. 16 illustrates an example of how a predictive component (model) in the form of a probabilistic classifier 1502 may be trained to make vehicle fault predictions, using the diagnostics data 13 and the linked repair data 15 for the vehicle population 1P—denoted vehicles 0 to N−1—as training data (together with the vehicle records 21 and environmental data if used). Steps in FIG. 16 are labelled as numbers in circles (and should not be confused with the un-circled labels used elsewhere).

This is based on supervised learning. The basis of supervised learning is that the model 1502 is trained to learn a function y(v) given a set of example values of y(v)—denoted (y₀, . . . , y_{N}) (the “significance labels”)—for respective input vectors (v₀, . . . , v_{N}), which are derived from the diagnostics data 13. Together, these make up a set of training data (training set). Each yₙ value can be thought of as class label assigned to the corresponding input vector vₙ. The power of an ML model is that it is able to generalize from the training set, to give a reliable estimate of y(v) for an input vector v it has not encountered before.

The model 1502 is a computer program that receives x as an input, and transforms it to generate an output y(v), according to a set of electronically stored model 1502 parameters {c₀, . . . , c_{M}}. Strictly speaking, y is a function of v and the model parameters, and thus could be legitimately denoted y(v, c₀, . . . , c_{M}), though that is avoided herein in the interests of conciseness.

During training, the model parameters are recursively adapted, according to a training algorithm, with the objective of minimizing a “loss function”:

O(y(vₙ)−yₙ)

for each (vₙ,yₙ) pairing in the training data, until a set of selected stopping criteria are met. Here, the loss objective function O provides a measure of difference between its inputs. In practice, what is often optimized is a “cost function”, which can comprise an aggregation of the loss functions across the training inputs (with regularization if necessary). A variety of different loss functions can be used, such as mean squared error, cross-entropy etc. One example of a suitable training algorithm is gradient descent, though different training algorithms can be used depending on the context. These are well known per se so are not described in any further detail.

The training set, that is the feature vectors and their category labels, are determined at Step 1 in FIG. 16.

For the task at hand, feature vectors v₀, . . . , V_{N-1} are derived as described above for vehicles n=0, . . . , N₁.

In this example, the label assigned to each input vector is a simple binary classification based on whether or not any vehicle fault event occurred in a prediction window relative to a timing associated with the input vector. However, as will be appreciated, this could be extended to multi-class labels.

Once the training set has been determined in this manner, then at Step 2, it is used to train the probabilistic classification model 1502, in the manner described above.

With the model 1502 trained then, at Step 3, the trained model 1502 can be used to make a vehicle prediction about a target vehicle T, for which no repair data is available (strictly speaking, for which no repair data is required).

To do this, a feature vector v_{T}∈V is determined for the target vehicle T using the available data, in exactly the same way as the training feature vectors are determined, and inputted to the trained model 1502. With a probabilistic binary classifier, the output will be a value that represents the likelihood of the vehicle experiencing a fault within the prediction window—64% in FIG. 16, though this is purely an example.

For a multiclass classifier, the output will be a vector of values y_{q} with q=1, . . . , M (M being the number of time categories). Provided a suitable probabilistic classification model is chosen and trained sensibly in accordance with the principles set out above, then each y_{q} value can be interpreted as a probability that the input vector v_{T} belongs to class q, which in turn can be interpreted as the probability of the target vehicle T experiencing a repair event with a timing value that falls within the corresponding time prediction window.

Examples of suitable probabilistic classification models include a logistic regression model, a gradient boosting machine, or a neural network with a probabilistic output (e.g. a softmax layer).

In ML terminology, a distinction is drawn between deterministic classification, in which a feature vector is assigned to a single class, and regression, in which a continuous output value is determined. Under this definition, probabilistic classification is a form of regression, with the continuous output being the class probability value(s). For this particular task, probabilistic classification may be preferred in some contexts, however deterministic classification could also be used, for example to assign a feature vector to one of a set of discrete risk categories, applying the same principles to generate feature vectors using (at least) driving style parameters, and training labels using vehicle fault history. If desired, a probabilistic classifier can be used to implement a discrete classifier, by selecting the highest probability category, or an inherently deterministic classification algorithm can be used.

As will be appreciated, the same principles could be applied to cost, using any suitable form of regression.

As noted the feature vectors (v₀, . . . , v_{N}), are derived from the diagnostics data 13, but they may also capture other forms of data in addition, such as vehicle attributes.

Although the technology has been described in relation to vehicles, the technology can also be applied to other forms of machine.

Another aspect of the present invention provides a computer-implemented method of predicting machine faults, the method comprising implementing, at a data processing stage, the following steps: receiving diagnostics data collected from a plurality of machines; receiving machine fault data recording fault events experienced by the machines; for each of the machines, determining, for at least one piece of diagnostics data collected from that machine, a significance label (training label) based on the machine fault data for that machine; and using the pieces of diagnostics data and their significance labels to make a machine fault event prediction for a target piece of diagnostics data.

Although specific embodiments of the inventions have been described, variants of the described embodiments will be apparent. The scope is not defined by the described embodiments but only by the accompanying claims.

1. A computer-implemented method of predicting vehicle failures comprising:
receiving, at a processing stage: i) a vehicle diagnostics dataset, which records historic diagnostic warning events for a population of multiple vehicles and an associated timing for each diagnostic warning event, and ii) a vehicle fault dataset, which records historic vehicle fault events experienced by at least some of the vehicles and an associated timing for each vehicle fault event, wherein the diagnostic warning events and vehicle fault events are associated in their respective datasets with cooperating vehicle identifiers;
wherein a predictive algorithm executed at the data processing stage determines whether or not each diagnostic warning event of a target type is time-associated with a vehicle fault event in that its associated timing is within a predetermined time window relative to that of any vehicle fault event associated with a matching vehicle identifier, and computes, based thereon, a significance value for the target type of diagnostic warning event, the significance value denoting the likelihood of a vehicle fault event occurring should a diagnostic warning event of the target type occur.

2. A method according to claim 1, wherein the predictive algorithm computes the significance value for the target type of diagnostic warning event by comparing the number of diagnostic warning events of the target type that are time-associated with vehicle fault events with the number of diagnostic warning events of the target type that are not time-associated with any vehicle fault events

3. A method according to claim 1 or 2, comprising a step of configuring, based on the computed significance value, a vehicle alert component to trigger the outputting of an alert for a vehicle in response to the detection of a diagnostic warning event of the target type by an on-board diagnostics system of the vehicle.

4. A method according to claim 3, wherein the alert is triggered in real-time in response to the detection of the diagnostic warning event.

5. A method according to claim 3 or 4, wherein the alert is outputted to a user of the vehicle.

6. A method according to any preceding claim, comprising a step of controlling a display device to display, to a user of the display device, an indication of the target diagnostic warning event and the significance value assigned to it.

7. A method according to any preceding claim, wherein a processing component of the data processing stage extracts, from the vehicle fault dataset, repair information for the target diagnostic warning event type, and associates the extracted repair information with the target diagnostic warning event type, the repair information being information about at least one of the vehicle fault events that is time-associated with one of the diagnostics warning events of the target type.

8. A method according to claim 7, wherein the extracted information comprises at least one of: a repair code, a repair frequency value, and a repair resource value.

9. A method according to claim 7 or 8 when dependent on claim 6, comprising controlling the display device to display the extracted information to the user of the display device.

10. A method according to any preceding claim, wherein the predictive algorithm computes respective significance values for multiple target diagnostic warning event types.

11. A method according to claim 10 when dependent on claim 7, wherein the processing component extracts repair information from the vehicle fault dataset for each of the target diagnostic warning event types and associates it therewith.

12. A method according to claim 10 or 11, comprising:
identifying at least one type of diagnostic warning event in a set of diagnostic data collected by an on-board data collection system of a vehicle;
determining that the significance value assigned to the identified type of diagnostic warning event meets a significance criterion; and
in response to that determination, performing a maintenance operation on the vehicle.

13. A method according to claim 12, wherein, in performing the maintenance operation, a fault with at least one component of the vehicle is identified and the identified component is adjusted, repaired or replaced to correct or mitigate the fault.

14. A method according to claim 12 or 13 when dependent on claim 11, wherein the fault is identified using the repair information associated with the identified diagnostic warning event type.

15. A method according to claim any to claims 10 to 14, comprising a step of determining an ordered list of at least some of the target diagnostic warning event types, which is ordered according to their respective significance values.

16. A method according to any to claims 10 to 15, comprising a step of determining a subset of the target diagnostic warning event types, each having a significance value that meets a significance condition.

17. A method according to claim 16, wherein the significance condition is that the significance value exceeds a threshold.

18. A method according to claim 16, wherein the significance condition is that the significance value is within a range of values.

19. A method according to claim 16 when dependent on claim 15, wherein the ordered list is an ordered list of the subset of target diagnostic warning events.

20. A method according to any of claims 16 to 18 when dependent on claim 3, wherein the alert component is configured to trigger the outputting of an alert for the vehicle in response to the detection of a diagnostic warning event of any of the subset of diagnostic warning event types.

21. A method according to any preceding claim, comprising determining a fault-associated vehicle count for the target diagnostic warning event type, which is a count of vehicles that have experienced a diagnostic warning event of the target type that is time-associated with a vehicle fault event.

22. A method according to any preceding claim, comprising a step of determining a fault-associated vehicles count for the target diagnostic warning event type, by counting vehicles that have experienced at least one diagnostic warning event of a type other than the target type, and which is time-associated with a vehicle fault event.

23. A method according to claim 22, wherein the fault-associated vehicles count is a total fault-associated vehicles count, corresponding to the sum of the number of vehicles that have experienced at least one diagnostic warning event of the target type, which is time-associated with a vehicle fault event, and the number of vehicles that have experienced at least one diagnostic warning event of a type other than the target type, which is time-associated with a vehicle fault event.

24. A method according to any preceding claim, wherein the predictive algorithm determines at least one vehicle fault prediction based on the significance value and a current interval of diagnostics data, the vehicle fault prediction relating to the number of vehicles expected to experience a vehicle fault event in a subsequent interval.

25. A method claim 16 or any claim dependent thereon, comprising determining an aggregate significance value by aggregating the significance values across the subset.

26. A method according to claims 24 and 25, wherein the vehicle fault prediction is determined for the subset of target diagnostic warning event types based on the aggregate significance value and the current interval of diagnostics data.

27. A method according to claim 2 or any claim dependent thereon, wherein the predictive algorithm determines the number of diagnostic warning events of the target type that are time-associated with vehicle fault events and at least one of: the number of diagnostic warning events of the target type that are not time-associated with vehicle fault events, and the total number of diagnostic warning events of the target type, in order to perform the comparison.

28. A method according to any preceding claim, wherein the significance value is a probabilistic value, denoting the conditional probability of a vehicle experiencing a fault event given that it has experienced a diagnostic warning event of the target type.

29. A method according to claims 27 and 28 wherein the probability value is estimated as a ratio of the number of diagnostic warning events of the target type that are time-associated with vehicle fault events and the total number of diagnostic warning events of the target type.

30. A method according to any preceding claim, wherein the vehicle fault dataset is a vehicle repair dataset and the vehicle fault events are vehicle repair events.

31. A method according to claim 30, wherein the vehicle fault dataset is formed of warranty claim records.

32. A method according to any of claims 1 to 30, wherein the vehicle fault dataset is a vehicle breakdown dataset and the vehicle fault events are vehicle breakdown events.

33. A method according to any preceding claim, wherein the vehicle diagnostics dataset is determined from a larger vehicle diagnostics dataset, by extracting, from the larger diagnostics dataset, diagnostics data for vehicle identifiers associated with matching vehicle attributes, such that the significance value is specific to a vehicle attribute or set of vehicle attributes.

34. A computer-implemented method of predicting machine failures comprising:
receiving, at a processing stage: i) a machine diagnostics dataset, which records historic diagnostic warning events for a population of multiple machines and an associated timing for each diagnostic warning event, and ii) a machine fault dataset, which records historic machine fault events experienced by at least some of the machines and an associated timing for each machine fault event, wherein the diagnostic warning events and machine fault events are associated in their respective datasets with cooperating machine identifiers;
wherein a predictive algorithm executed at the data processing stage determines whether or not each diagnostic warning event of a target type is time-associated with a machine fault event in that its associated timing is within a predetermined time window relative to that of any machine fault event associated with a matching machine identifier, and computes, based thereon, a significance value for the target type of diagnostic warning event, the significance value denoting the likelihood of a machine fault event occurring should a diagnostic warning event of the target type occur.

35. A computer-implemented method of predicting vehicle faults, the method comprising implementing, at a data processing stage, the following steps:
receiving diagnostics data and associated timing data collected from a plurality of vehicles;
receiving vehicle fault data recording fault events experienced by at least some of the vehicles, each vehicle fault event having an associated timing;
for each of the vehicles, determining a significance label for at least one piece of diagnostics data collected that vehicle, the significance label indicating whether or not that vehicle has experienced a fault event within a prediction window, the prediction time widow being defined relative to a timing associated with the piece of diagnostics data; and
using the pieces of diagnostics data and their significance labels to make a vehicle fault event prediction for a target piece of diagnostics data.

36. A computer-implemented method according to claim 35, wherein the pieces of diagnostics data and their significance labels are used to train a predictive component, executed at the data processing stage, to learn causal associations between pieces of diagnostics data and vehicle fault events, wherein the vehicle fault event prediction is outputted by the trained predictive component based on the target piece of diagnostics data.

37. A computer-implemented method according to claim 35 or 36, wherein the vehicle fault event prediction comprises a significance value for the target piece of diagnostics data, denoting the likelihood of a vehicle fault event occurring within the prediction window given the target piece of diagnostics data.

38. A computer-implemented method according to claim 37, wherein the significance value denotes the likelihood of a vehicle fault event occurring within the prediction window as defined relative to a timing associated with the target piece of diagnostics data.

39. A computer-implemented method according to any of claims 35 to 38, wherein each piece of diagnostics data is a portion of diagnostics data collected within a history window.

40. A computer-implemented method according to claim 39, wherein the history window has a fixed length.

41. A computer implemented method according to claim 40, wherein the history window has a variable length.

42. A computer implemented method according to claim 41, wherein the history window length for each portion of diagnostics data is provided as an input to the predictive component.

43. A computer-implemented method according to any of claims 35 to 38, wherein each piece of diagnostics data is in the form of an individual diagnostics warning event.

44. A computer-implemented method according to claim 36 or any claim dependent thereon, comprising:
processing each of the pieces of diagnostics data to generate a set of summary data therefrom, wherein the predictive component is trained using the sets of summary data and the associated significance labels; and
processing the target piece of diagnostics data to determine a set of summary data therefrom, wherein the vehicle fault event prediction is outputted by the trained predictive component based on the set of summary data determined from the target piece of diagnostics data.

45. A computer-implemented method according to claim 44, wherein each set of summary data comprises one or more diagnostic warning event counts.

46. A computer-implemented method according to any preceding claim, wherein the diagnostics data received at the data processing stage comprises a sequence of diagnostic warning events.

47. A computer-implemented method according to any preceding claim, wherein the diagnostics data received at the data processing stage comprises raw diagnostics data.

48. A computer-implemented method according to any preceding claim, comprising a step of performing an analysis of the diagnostics data independently of the vehicle fault data, wherein the determining step and/or the using step are performed in dependence on the analysis.

49. A computer-implemented method according to claim 48, wherein the analysis comprises at least one of the following: a statistical analysis, an unsupervised machine learning analysis, and a topological data analysis.

50. A computer-implemented method according to claim 37, wherein the predictive component is trained by optimizing a function of the significance labels and the output of the predictive component during the training.

51. A computer-implemented method according to any preceding claim, wherein each significance label indicates whether or not that vehicle has experienced a fault event within the prediction window.

52. A computer-implemented method according to any preceding claim, wherein each of the vehicle fault events is associated with a resource value and each significance label is determined based on the resource value associated with any vehicle fault event experienced in the prediction window, wherein the vehicle fault prediction comprises a predicted resource value for the prediction window.

53. A computer-implemented method according to any preceding claim, which is performed in real-time.

54. A computer-implemented method according to claim 44 or any claim dependent thereon, wherein each set of summary data comprises one or more driving style parameters.

55. The method according to any preceding claim, wherein each fault event has been identified by manual inspection of the vehicle or machine in which it occurred.

56. A data processing stage comprising:
electronic storage configured to store computer readable instructions; and
one or more processors coupled to the electronic storage and configured to execute the computer readable instructions, the computer readable instructions being configured, when executed on the one or more processors, to implement the method of any preceding claim.

57. A computer program product comprising computer readable instructions stored on a computer readable storage medium and configured, when executed at a data processing stage, to implement the method of any preceding method claim.
